(19) United States
(12) Patent Application Publication
(10) Pub. No.: US 2021/0227849 A1
(43) Pub. Date: Jul. 29, 2021

(54) COMPOSITIONS AND METHODS FOR FROZEN CONFECTIONS

(71) Applicant: Ripple Foods, PBC, Berkeley, CA (US)

(72) Inventors: Sameen Kiayei, Oakland, CA (US); Ruolin Zhu, San Francisco, CA (US)

(73) Assignee: Ripple Foods, PBC, Berkeley, CA (US)

(21) Appl. No.: 17/159,301

(22) Filed: Jan. 27, 2021

Related U.S. Application Data
(60) Provisional application No. 62/966,627, filed on Jan. 28, 2020.

(51) Int. Cl. A23G 9/38; A23G 9/34; A23G 9/32; A23G 9/08; A23J 1/14; A23J 3/14

(52) U.S. Cl. CPC A23G 9/38; A23G 9/34; A23G 9/327; A23V 2002/00; A23G 9/08; A23J 1/14; A23J 3/14; A23G 9/325

(57) ABSTRACT

A dairy-free frozen confection comprising a plant protein, a sweetener, an oil, a bulking component, a texturizer, and an emulsifier, and optionally including flavorants and a solubilizer is disclosed. The dairy-free frozen confection can have advantageous shininess and/or creaminess, with additional enhanced organoleptic characteristics such as mouth feel or melt, and/or reduced off taste. Also disclosed are processes for making a dairy-free frozen confection product which requires an ageing step of a chilled composition.

### TECHNICAL FIELD

This disclosure relates to frozen confection food products. More particularly, this disclosure relates to dairy-free frozen confections having superior organoleptic properties. A dairy-free frozen confection can have superior appearance, taste and other properties, such as shininess and/or creamy texture and mouth feel or melt.

### BACKGROUND

The annual global market for frozen confection food products is billions of units. Some of the most highly desired products are dairy-free frozen confections. However, it has been difficult to make dairy-free frozen confection products with appealing appearance and taste as compared to those with dairy components. Dairy-containing frozen confections can have significant and appealing shininess, as well as creamy texture and mouth feel or melt.

In addition, vegan products are highly desirable for diet and health benefits such as nutrition, low or no cholesterol, and reduced allergenic and intolerance effects by using non-animal-based food materials. Vegan products can answer other significant social concerns such as the use of additives and biological agents in animal-based supplies.

Substitutes for some dairy components are available. However, drawbacks of such components include the difficulty of gaining consumer acceptance. More particularly, the pleasing appearance, texture and/or mouth feel of dairy-based products can be difficult to obtain with dairy substitutes. Drawbacks of certain dairy substitutes may include significant off taste. Additional drawbacks can include reduced protein level, which can generally reduce nutritional value. Further drawbacks of non-dairy components include inability to reach higher levels of overrun in production.

The appearance and taste of dairy-containing frozen confections depends on the processing and the composition. When dairy is used, an ageing step in the process is typically needed to modify the ultimate appearance and taste of a frozen confection. The dairy mix undergoes physicochemical changes upon ageing. However, conventional processes for non-dairy frozen confections do not use an ageing step because without the dairy component the same physicochemical changes do not occur. Consequently, conventional dairy-free frozen confections can lack significant shininess and the appealing creaminess of dairy-containing frozen confections.

What is needed are compositions and processes for making frozen confections which are dairy-free yet provide shininess and creamy texture with less unfavorable off taste.

There is a need for methods and compositions for making dairy-free frozen confections which retain the pleasing appearance, taste, and/or nutritional content of products containing dairy components.

### BRIEF SUMMARY

This invention relates to frozen confection compositions and methods for making the compositions. More particularly, this invention discloses compositions and methods for making dairy-free frozen confections which retain surprisingly pleasing shiny appearance and creamy taste.

In some aspects, this invention provides compositions and processes for making frozen confections which are dairy-free and have a shiny appearance, especially when scooped.

In certain aspects, this invention provides compositions and processes for making frozen confections which are dairy-free and have a creamy texture, which compares favorably to a dairy-containing product.

In additional aspects, this invention provides compositions and processes for making frozen confections which are dairy-free and have advantageously reduced off taste. A reduced off taste can be reflected in a reduced unpleasant aftertaste, or by consumer overall preference.

Methods and compositions of this disclosure include making a dairy-free frozen confection having a pleasing appearance and/or taste as compared to a product containing dairy components, and/or a sufficient nutritional content.

In some aspects, this invention provides methods and compositions for making dairy-free frozen confections by ageing a composition to enhance shiny appearance and creamy taste. Aspects of this invention can provide a frozen confection with surprisingly increased shininess and/or creamy mouth feel or melt.

Additional aspects of this disclosure include compositions for flavored frozen confections.

Embodiments of this invention include the following:

A frozen confection, comprising:

a sweetener in an amount of from 11% to 18% by weight;

an oil in an amount of from 7% to 15% by weight;

a bulking component in an amount of from 7% to 15% by weight;

a plant protein isolate and/or refined plant protein in an amount of from 2% to 6% by weight;

a texturizer in an amount of from 0.5% to 5% by weight; and

an emulsifier, in some examples, comprising two or more gums (gums may also act as thickening agents), wherein the total is from 0.2% to 2% by weight;

wherein the frozen confection is dairy-free and gluten-free.

The frozen confection may further comprise a flavorant in an amount up to 5% by weight.

The frozen confection may further comprise a lecithin in an amount up to 1% by weight.

The frozen confection may further comprise a solubilizer in an amount up to 0.5% by weight.

The frozen confection may further comprise a deacidifier in an amount up to 1% by weight.

The sweetener can be selected from cane sugar, beet sugar sucrose, allulose, fructose, glucose, maltose, galactose, dextrose, corn syrup, and combinations thereof.

The oil can be selected from coconut oil, soybean oil, sunflower oil, palm oil, flaxseed oil, oat oil, illipe oil, shea oil, shorea robusta oil, cocoa butter oil, corn oil, aloe vera oil, avocado oil, baobab oil, calendula oil, canola oil, pumpkin oil, cottonseed oil, evening primrose oil, grape seed oil, jojoba oil, neem oil, olive oil, rapeseed oil, sesame oil, and combinations thereof.

The bulking component can be selected from tapioca syrup, polydextrose, maltodextrin, corn syrup solids, and combinations thereof.

The plant protein isolate and/or refined plant protein can be an isolate of a legume. The legume may be selected from pea, lentil, lupin, and chickpea. In some embodiments, the pea can be selected from a whole pea, a component of pea, a non-genetically modified pea, a commoditized pea, and combinations thereof. In certain embodiments, the pea is Pisum sativum. The plant protein isolate and/or refined plant protein may comprise about 70% to about 90% by weight of protein, or about 5-95% by weight of protein. The plant protein isolate isolate and/or refined plant protein may comprise at least about 5%, 10%, 20%, 30%, 40%, 50%, 60%, 70%, 80%, or 90% by weight of protein. The plant protein isolate and/or refined plant protein can be extracted in a solvent to remove lipids, or heat treated to remove volatiles, or fermented, or gelled.

The texturizer can be selected from inulin, psyllium, oligofructose, galacto-oligosaccharides, fibers, citrus fiber, and combinations thereof.

The gums may be selected from guar gum, gum Arabic, locust bean gum, carob gum, pectins, and combinations thereof. In some embodiments, the gums may be guar gum, gum Arabic, and locust bean gum.

The pH of the frozen confection may be from 7.1 to 8.3, or from 7.3 to 8.3.

In some embodiments, the frozen confection may have reduced off taste, as compared to a conventional dairy-free frozen confection. In further embodiments, the frozen confection may have a shiny appearance when scooped, as compared to a dairy ice cream. In certain embodiments, the frozen confection can have a creamy mouth feel, as compared to a dairy ice cream.

The frozen confection may have a serving size of from 50 mL to 15,000 mL, or from 50 mL to 4000 mL, or from 50 mL to 1000 mL, or from 50 mL to 500 mL, or from 50 mL to 250 mL, or from 50 mL to 125 mL. In some embodiments, the frozen confection can comprise confectionary inclusions.

The frozen confection may have an overrun of 40-150%, or from 50-70%.

The frozen confection can be aged at a temperature of about 4-10° C. (40-50° F.) for at least 2 hours before filling and freezing.

Embodiments of this invention further contemplate processes for making a dairy-free frozen confection product, by batching a dairy-free frozen confection composition with pH adjustment, homogenizing the composition, thermally processing the composition, chilling at 4-10° C. (40-50° F.), and ageing at least a portion of the composition at a temperature of about 4-10° C. (40-50° F.) for at least about 2 hours, or 4-12 hours, and filling and freezing the composition into the frozen confection product. The use of an ageing step in a dairy-free process and product of this invention is an unexpectedly advantageous feature which can provide enhanced properties (e.g., shininess).

The batching may comprise preparing a dairy-free frozen confection composition comprising:

a sweetener in an amount of from 11% to 18% by weight;

an oil in an amount of from 7% to 15% by weight;

a bulking component in an amount of from 7% to 15% by weight;

a plant protein isolate and/or refined plant protein in an amount of from 2% to 6% by weight;

a texturizer in an amount of from 0.5% to 5% by weight; and

an emulsifier comprising two or more gums in a total amount of from 0.2% to 2% by weight.

The homogenizing can be performed at from about 10 MPa to about 18 MPa (about 1500 to about 2500 psi), or about 5-25 MPa. The homogenizing can be performed in one or more stages at different pressures.

The thermal processing may be performed for about 30 seconds to about 30 minutes and about 57° C. to 99° C., or about 79° C. (about 135° F. to 210° F., or about 175° F., respectively) using an indirect high temperature short time system. In some embodiments, flavorants and/or inclusions can be added during the chilling step.

In certain embodiments, the process can have an overrun of 40-150%, or 50-70%.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

The following U.S. patents and U.S. published patent applications are each incorporated by reference in their entirety into this application:

U. S. Patent Publication No. 2019/0000112 A1 (Ser. No. 16/068,567), published Jan. 3, 2019 and titled, “Product Analogs or Components of Such Analogs and Processes for Making Same.”

Other references incorporated by reference may be listed throughout the application.

### BRIEF DESCRIPTION OF THE DRAWINGS

In the accompanying drawings, which are incorporated in and constitute a part of the specification, embodiments of the disclosed inventions are illustrated. It will be appreciated that the embodiments illustrated in the drawings are shown for purposes of illustration and not for limitation. It will be appreciated that changes, modifications and deviations from the embodiments illustrated in the drawings may be made without departing from the spirit and scope of the invention, as disclosed below.

FIGS. 1A, 1B, 1C, 1D, 1E and 1F illustrate scooped, frozen, non-dairy confections.

### DETAILED DESCRIPTION OF THE INVENTION

### Definitions

Unless defined otherwise, all technical and scientific terms used herein have the same meaning as commonly understood by one of ordinary skill in the art to which the present invention pertains. It is to be understood that the terminology used herein is for describing particular embodiments only and is not intended to be limiting. For purposes of interpreting this disclosure, the following description of terms will apply and, where appropriate, a term used in the singular form will also include the plural form and vice versa.

Herein, “ageing” generally refers to a process step that occurs before freezing of the composition that will become the frozen confection. In some examples, the composition, prior to freezing, is maintained at a temperature or within a temperature range for a time prior to freezing. In some examples, the ageing process may improve appearance (e.g., shininess) and/or taste of a frozen confection.

Herein, “allergenic” means having the capability to induce allergy. “Non-allergenic” means not capable of causing allergy. “Hypoallergenic” means having a reduced ability to induce allergy. Generally, allergens are allergenic. In some examples, allergens refer to 8 significant food allergens recognized in the United States, including milk (including whey protein and caseinate), eggs, fish, crustacean shellfish, tree nuts, peanuts, wheat and soybeans.

Herein, “aqueous solubility” refers to the maximum amount of a substance (e.g., refined protein preparation) that can be dissolved in water at a given temperature.

Herein, “batching” or “batch production” refers to production methods where one batch is made and finished before another batch is started.

Herein, “bulking component” or “bulking agent” refers to additives that increase the volume and/or weight of a food, generally without affecting it taste and utility. In some examples, bulking agents may increase sweetness, while limiting calories.

Herein, “chilling” means to reduce the temperature or to make something cold.

Herein, “coloring agent” generally refers to a substance that imparts a color to another substance. Herein, coloring agents may be used to impart a desirable color to a food

Herein, “confection” generally refers to sweet foods, which may be eaten as snack foods. Some example confections may include baked goods. Some example confections may include sugar confections. Sugar confections may include candy, chocolate, candied fruits and nuts, chewing gum, ice-cream and the like. Some confections may be free of sugar. Some confections may be dairy-free. Some confections may be frozen or chilled.

Herein, “conventional” means in accordance with what is generally done or believed.

Herein, “dairy” refers to food containing or produced from the milk of mammals.

Herein, “deacidifier” means a substance or compound that increases the pH of a food product. Herein, deacidifiers are generally edible.

Herein, “edible” means fit to be eaten.

Herein, “emulsifier” refers to substances that stabilize emulsions.

Herein, “emulsions” are colloidal solutions with both the dispersed phase and the dispersion medium being liquid. Emulsions can be formed from two liquids that are not miscible. In some examples, an emulsion is an oil (dispersed phase) in water (dispersion medium) emulsion. In unstable emulsions, the liquids will separate in absence of agitation.

Herein, “extract,” when used as a verb, generally refers to a separation process where one or more substances or compounds are removed from another substance.

Herein, “fat” generally refers to lipids. Herein, fats include oils. Herein, fats generally refer to non-animal fats.

Herein, “filling” generally refers to placing a food product into a container or packaging.

Herein, “flavorant” or “flavoring agent” refers to a substance that imparts flavor to another substance. Herein, flavoring agents may be used to make product taste more natural.

Herein, “food” refers to something edible.

Herein, “fracturability” refers to the capability of frozen confection to break across a plane, often during scooping. In some instances, the force needed to cause this fracture may be measured.

Herein, “freezing” means to cause the temperature of a substance to fall to or below 32° Fahrenheit.

Herein, “frozen confection” refers to a confection for consumption that is in a frozen or chilled state. Example frozen confections may include hard and soft ice-cream, frozen custard, sherbet, gelato, sorbet, frozen yogurt, sundaes, popsicles and the like.

Herein, “gluten” refers to a group of proteins (e.g., gliadin and glutenin) present in cereal grains (e.g., wheat).

Herein, “gluten free” “nongluten” means lacking or having a reduced amount of gluten.

Herein, “homogeneous” refers to a uniform composition. Herein, frozen confections may be referred to as homogeneous in the sense that any edible particles or inclusions in the frozen confection are relatively small. For example, refined protein used in the frozen confections described here may be in the form of a powder, and when formed into the product, the particles of the protein are generally indistinguishable from the rest of the product by the human eye. In contrast, a frozen confection containing visible inclusions (e.g., dried fruits, nuts, seeds, flavored chips, etc.) are generally not considered as homogeneous in this disclosure.

Herein, “homogenizing” refers to a mixing process that results in a uniform product. In some examples, homogenizing refers to a process where fats/oils are emulsified in a liquid.

Herein, “inclusions” refer to a body or particle recognizably distinct from the substance in which it is embedded. Herein, inclusions in a food product are generally of a size that are detectable visually, using the human eye.

Herein, “isolated protein” or “protein isolate” refers to a protein or population of proteins that are substantially isolated from a source. That is, non-protein components have been substantially removed or at least reduced in a preparation of isolated proteins. In some examples, components that may be removed may include insoluble polysaccharide, soluble carbohydrate, ash, other minor constituents and other components. Generally, herein, isolated protein refers to a population of proteins from one or more plant sources. Isolated protein may be in variety of forms, including for example, protein isolate, protein concentrate, protein flour, meal and/or combinations thereof.

Herein, “mouthfeel” refers to physical sensations in an individual's mouth caused by food, as opposed to taste of the food. In combination with taste and smell, mouthfeel determines the overall flavor of a food. Mouthfeel is sometimes also called “texture”.

Herein, “gums” generally refers to exopolysaccharides produced by bacterial fermentation. In some examples, gums may act as bulking agents, emulsifiers, stabilizers and/or thickeners.

The term “non-dairy” or “dairy-free” as used here means that the product or formulation has no dairy-based ingredients or less than 0.5% by weight of dairy-based ingredients. The term “substantially non-dairy” as used in the present disclosure means that the product or formulation has less than 5% by weight of dairy-based ingredients.

Herein, “off taste” refers to an unpleasant taste in the mouth. In some examples, off taste may be taints in food products that may be caused by the presence of undesirable substances. In some examples, the off taste may be an aftertaste. An “aftertaste” refers to a persistent, sometimes unpleasant sensation (e.g., taste) after a substance has been removed from the mouth. In some instances, the taste may be experienced near the end, at the end, or after the end of the chewing or swallowing process of a food or beverage.

Herein, “oil” refers to a fat that is in liquid form. Herein, oils generally refer to non-animal oils.

Herein, “overrun” refers to an increase (e.g., percent increase in volume) of a frozen confection (e.g., ice cream) that is greater than the amount of mix used to produce the frozen confection. In some examples, gas is incorporated into the product during the freezing process which expands the volume of the product. In an example, if the volume of the mix of ingredients used to make a frozen confection has a volume of 1 liter and the amount of frozen confection that results from the making is 1.5 liter, the overrun is 50%.

Herein, “particle,” refers to small localized object or entity.

Herein, “particle size” generally refers to a D×50 measurement (e.g., in μm) for a population of particles having a distribution of sizes.

Herein, “pH adjustment” means altering the pH of a composition (e.g., a liquid), generally by addition of acid or base. In some examples, pH adjustment is performed using acidifiers or deacidifiers.

Herein, “plant protein” refers to proteins originate from plants (as opposed to animals).

Herein, “plant protein isolate” refers to isolated protein from plants.

Herein, “protein” refers to a chain or polymer of amino acids, covalently joined by peptide bonds.

Herein, “refined protein” refers to isolated protein that has been processed.

Herein, “salt” refers to a compound made by joining a positively charged acid with a negatively charged base.

Herein, “salt-precipitated protein” refers to refined plant protein made by the process described herein and in U.S. Patent Publication No. 2019/0000112 A1 (Ser. No. 16/068,567), published Jan. 3, 2019 and titled, “Product Analogs or Components of Such Analogs and Processes for Making Same.” Protein prepared using a process for salt precipitation that uses, for example, a calcium salt may be called “calcium-precipitated protein.”

Herein, “shiny” refers to a visual appearance of something that reflects light (e.g., glossy, bright, gleaming).

Herein, “scooped” refers to removing a frozen confection from its packaging using a spoon or ice cream scoop.

Herein, “solid” refers to firm and stable in shape; not liquid or fluid.

Herein, “solubilizer” or “dispersing agent” refers to substances that “hold air” and facilitate the frozen confections retaining their shape.

Herein, “solution pH” refers to pH of water into which an amount of refined protein preparation has been dissolved. Herein, the pH of 10% (w/w) supersaturated solutions of refined protein preparations were determined

Herein, “source,” refers to the origin of something or the place where something was obtained.

Herein, “sugar” refers to sweet-tasting, soluble carbohydrates. Some example sugars include the disaccharides, sucrose (glucose and fructose) lactose (glucose and galactose) and maltose (two molecules of glucose). Example simple sugars, called monosaccharides, include glucose, fructose, allulose, and galactose. Generally, sugars are sweetening agents.

Herein, “sweetener” or “sweetening agent” refers to a substance capable of imparting a taste or flavor characteristic of sugar, honey, and the like, to food. Sweetening agents may include non-caloric sweeteners such as aspartame, saccharin, stevia, monk fruits and protein-based sweeteners. Sweet is a taste sensation that is not bitter, sour or salty.

Herein, “texture” means the appearance, feel and/or consistency of a substance or surface. Regarding food, texture may be defined as the properties of a food that include physical characteristics that come from structural elements of the food which are generally sensed by touch and are related to deformation, disintegration and flow of the food under a force. Some parameters of texture include adhesiveness, chewiness, cohesiveness, fracturability, gumminess, hardness, resilience and springiness. In some examples, some of these parameters may be determined by a Texture Profile Analysis (TPA), using an example instrument called a texture analyzer. Also see “mouthfeel” herein. Related to this, “rheology” is the branch of physics that studies deformation and flow of matter.

Herein, “texturizer” refers to substances that change (e.g., increase) the texture and/or mouthfeel of a product.

Herein, “thermally processing” refers to process for sterilizing and/or removing potential toxins from food products using high temperatures

Herein, “thickening agent” refers to a substance that increases the viscosity of a liquid. Generally, thickening agents increase viscosity without substantially changing other properties of the liquid. The thickening agents referred to in this application are generally edible thickening agents. In some examples, the thickening agents used herein may dissolve in a liquid as a colloid that forms a cohesive internal structure (e.g., a gel).

### Frozen Confections

Generally, frozen confections are sweet foods that are in a frozen or chilled state. This invention provides frozen confection compositions and methods for making frozen confections. In some embodiments, this disclosure includes compositions and methods for making dairy-free frozen confections with enhanced organoleptic properties.

A dairy-free frozen confection of this disclosure can retain a surprisingly pleasing shiny appearance, especially when scooped. The shininess of a frozen confection of this invention can be reflected in a lack of ice-like or frozen appearance.

In further embodiments, this disclosure includes compositions and methods for making dairy-free frozen confections which have an advantageous creamy taste. The advantageous creaminess of a frozen confection of this invention can be reflected in a creamy mouth feel or melt.

In additional embodiments, this invention includes frozen confections which are dairy-free and have advantageously reduced off taste. A reduced off taste can be reflected in a reduced unpleasant aftertaste. In such embodiments, a reduced unpleasant aftertaste shows that the frozen confection product compares surprisingly well to a dairy-containing product, as reflected by consumer preference and/or acceptance.

This invention further contemplates methods and compositions for making a dairy-free frozen confection having a pleasing appearance and/or taste, as compared to a product containing dairy components, and which can have a beneficial nutritional content such as a protein level.

Embodiments of this invention can provide frozen confectionary products that are made from vegan, non-animal sources. A frozen confectionary product herein can advantageously provide a comparable appearance and/or taste as compared to a dairy-containing product, yet without animal-derived or dairy components.

In further embodiments, this invention includes processes for production of frozen confectionary products, which are vegan-based and dairy-free. The processes can produce frozen confections that have surprising shininess, especially when scooped. The processes can further provide frozen confections having creamy texture and/or mouth feel, which compare favorably to that of a dairy containing product.

Embodiments of this invention may utilize ageing of a composition to provide enhanced shiny appearance and/or creaminess. An ageing step in the process can be used to control the appearance and/or taste of a frozen confection. Ageing of a chilled composition before freezing and preparing final product can provide unexpectedly advantageous shininess of the product, especially when scooped, as well as an appealing creaminess. Use of an ageing step in the process is a surprising feature which can result in such enhanced properties.

In general, embodiments of this invention include frozen confections in various dessert and/or single serving formats. In further aspects, the dairy-free frozen confections can contain various flavorants.

In some embodiments, a product of this invention may be substantially free of cholesterol, trans-fats, and/or artificial sweeteners.

### Ingredients

In some examples, the ingredients used in the frozen confections disclosed herein may include non-dairy and/or plant-based protein, sweetening agents, plant-based fats, including plant-based oils, bulking components, thickening agents, emulsifiers, texturizers, flavoring agents, salt, various carbohydrates, coloring agents, water, vitamins and/or other nutritional supplements, enzymes, and other ingredients.

Generally, the amount of an ingredient or ingredients in a formulation or final frozen confection product is given in “percent by weight” or “weight percent” of a composition. The weight percent of various ingredients may refer to the amount of the ingredient in the formulation for making a frozen confection (e.g., batter or dough) or in the final frozen confection product. Generally, formulation or final product will be specified.

Generally, the ingredients described in the sections below are grouped by chemical category (e.g., protein, fat, carbohydrate). In some examples, however, ingredients are grouped into functional categories (e.g., emulsifier, sweetening agent, bulking component, flavoring agent). In some examples, an ingredient grouped in a chemical category may have one or more activities of one or more of the functional categories (e.g., some carbohydrates may have emulsifier activity), even though the ingredient is not listed as part of the functional category. In some examples, an ingredient grouped in a functional category may contain chemical substances that could be grouped into one or more chemical categories. In some examples, an ingredient grouped in a chemical category may contain substances from one or more other chemical categories. In some examples, an ingredient grouped in a functional category may have at least some activity that could be grouped in other functional categories. Grouping an ingredient in one category may not preclude that it may have chemical composition and/or activity that could be classified in a different category.

In some examples, the frozen confections disclosed herein may include about 250-270 calories per serving.

### Compositions for Frozen Confections

Embodiments of this invention provide compositions for frozen confections.

In some aspects, dairy-free frozen confection compositions of this invention can be vegan and gluten-free.

A composition of this disclosure may contain a sweetener, as well as an oil component.

In certain embodiments, a legume protein can be used in the composition.

A composition for making a frozen confection may include a component derived from a legume, a cereal grain, or a flax.

Embodiments of this invention include compositions containing a pea protein isolate. A pea protein isolate component can provide a beneficial nutritional content, as well as taste and appearance.

A composition may further contain a bulking component to provide needed overall texture and volume.

In certain aspects, a composition can contain a texturizer. A texturizer may enhance properties for tasting a product, mouthfeel, as well as provide a beneficial nutritional content.

In certain aspects, a composition can contain an emulsifier. An emulsifier can include gums, for example, for providing needed consistency of a composition.

In certain embodiments, frozen confections can be made from non-animal, vegan, and/or natural sources. A dairy-free frozen confection of this invention may have surprisingly advantageous appearance, texture, taste, mouth feel or mouth melt, flavor, and/or nutritional content.

A composition for making a frozen confection may have levels of protein, saturated fat and/or carbohydrate less than a comparable dairy-containing product.

A composition for making a frozen confection may contain no cholesterol or lactose. In certain embodiments, a frozen confection may be cholesterol-free. In additional embodiments, a frozen confection may be lactose-free.

In general, non-animal, natural sources may include naturally occurring plant, algae, fungus, and/or microbe sources.

Advantages of the compositions and products of this invention can be evaluated, for example, by blind taste testing panels and consumer opinion reports. A taste profile can be determined by a trained taste panel.

In some embodiments, an aqueous base formula can be made as shown in Table 1.

TABLE 1
Aqueous base formula

| INGREDIENT | Wt % |
|---|---|
| Sweetener | 11-18 |
| Oil | 7-15 |
| Bulking component | 7-15 |
| Plant protein isolate and/or refined plant protein | 2-6 |
| Texturizer | 0.5-5 |
| Emulsifiers | 0.2-2 |

In further embodiments, an aqueous base formula can be made as shown in Table 2.

TABLE 2
Aqueous base formula

| INGREDIENT | Wt % |
|---|---|
| Sweetener | 11-18 |
| Oil | 7-15 |
| Bulking component | 7-15 |
| Plant protein isolate and/or refined plant protein | 2-6 |
| Texturizer | 0.5-5 |
| Emulsifiers | 0.2-2 |
| Solubilizer | ≤0.5 |

In additional embodiments, an aqueous base formula can be made as shown in Table 3.

TABLE 3
Aqueous base formula

| INGREDIENT | Wt % |
|---|---|
| Sweetener | 11-18 |
| Oil | 7-15 |
| Bulking component | 7-15 |
| Plant protein isolate and/or refined plant protein | 2-6 |
| Texturizer | 0.5-5 |
| Emulsifiers | 0.2-2 |
| Solubilizer | ≤0.5 |
| Flavorants | ≤2.5 |

In some embodiments, the aqueous base formulation may include further ingredients, or further ingredients may be added to the base formulation at some other time during the process for making the frozen confections, the ingredients including one or more of: lecithins, deacidifiers, inclusions, nutritional components and the like.

### Methods for Making Frozen Confections

Embodiments of this invention further contemplate methods for making a frozen confection.

In certain aspects, a process for making a dairy-free frozen confection can include an ageing step of a composition before freezing to prepare a final frozen confection product. An ageing step can surprisingly increase the shiny appearance and/or creaminess of a final product.

In further aspects, this invention can control and achieve surprising levels of overrun for a non-dairy product. A product of this invention may have a surprisingly advantageous overrun of 40-150%. In some embodiments, the overrun can be from 40% to 180%, or from 50% to 150%, or from 60% to 180%, or from 60% to 150%, or from 50% to 70%. Overrun may be produced by incorporation of a gas into the product. The gas can be a food grade gas such as air, nitrogen, or carbon dioxide. Some examples of overrun are given in Robert T. Marshall, Ice Cream 6th Edition (2003 Academic, New York), which is hereby incorporated by reference.

A process for making a frozen confection may include steps for batching, pH adjusting, homogenizing, thermal processing, chilling, ageing, flavoring, adding inclusions, freezing, filling, freezing and shipping.

In a batching step, ingredients may be added, generally with continuous recirculation from a liquefier to a batch tank.

In a pH adjusting step, any one or more of potassium hydroxide, sodium hydroxide, sodium phosphate, and potassium phosphate, or other pH adjusters, may be added to adjust pH to a target.

In a homogenizing step, the batch base may be homogenized. In some examples, homogenization is performed at from about 10 MPa to about 18 MPa (about 1500 to about 2500 psi), or about 5 to about 25 MPa, or in some embodiments at about 11 MPa (1600 psi) total comprising a first stage at about 7.6 MPa (1100 psi) and a second stage at about 3.4 MPa (500 psi).

In a thermal processing step, the batch base may be processed for 30 sec and 79° C. (175° F.) using an indirect high temperature short time (HTST) system. In some embodiments, the thermal processing can be performed for about 30 seconds to about 30 minutes and about 57° C. to 99° C., or about 79° C. (about 135° F. to 210° F., or about 175° F., respectively) using an indirect high temperature short time system.

In a chilling step, the batch base may be chilled to a temperature of about 7° C. (45° F.), or 4-10° C. (40-50° F.).

In an ageing step, the chilled batch may be aged at a temperature of about 7° C. (45° F.), or 4-10° C. (40-50° F.), for at least 1 hour, or at least 2 hours, or at least 3 hours, or from 4-12 hours before filling. In certain embodiments, the batch may be aged for 2-8 hours, or 3-8 hours, or 4-6 hours, or 4-5 hours before filling.

In a flavoring step, flavorants may be added to the chilled base.

In an inclusion adding step, confectionary inclusions may be added.

In a freezing step, the resulting product may be frozen in a continuous freezer.

In a filling step, a container may be filled, and the resulting product can be hardened in a blast freezer.

In a shipping step, the final frozen product may be packaged, stored and shipped.

In some embodiments, batching can include warming coconut oil until liquid at about 40° C. (104° F.). Guar and locust bean gum can be pre-blended-in with 50 lbs of sugar. A KOH solution at 45% can be made as a 50/50 ratio of water and 90% KOH flakes.

In further embodiments, batching can include heating 50% of the water to about 71° C. (160° F.), adding plant protein isolate and/or refined plant protein, lecithin, acacia, inulin, and cocoa powder, if any, and keeping under constant recirculation for 15 minutes. Lecithin and/or acacia can also be added with the oil component. Tapioca syrup solids may be added. The remaining 50% of water can be brought to a cool temperature. Sugar can be added less a pre-blended amount. Dipotassium phosphate can be added, along with salt, and any pre-blended mixture of sugar, locust bean gum and guar. Coconut oil can be added. The total mixture can be pumped to a batch tank and mixed until a homogeneous blend is obtained. The pH of the well-blended mix can be measured. KOH solution can be added to the batch tank to adjust pH preferably to 7.8±0.1. In some embodiments, the pH can be adjusted from 7.1 to 8.3, or from 7.3 to 8.3, or from 7.5 to 8.0, or from 7.7 to 7.9.

In additional embodiments, processing can include keeping the blend under constant agitation in pre-processing to avoid settling of protein. The blend can be homogenized at about 18 MPa (2,500 psi), in some embodiments with a first stage at about 14 MPa (2,000 psi), and a second stage at about 3-4 MPa (500 psi). The resulting product can be processed using an indirect HTST system for a minimum of 30 s at about 79° C. (175° F.).

The resulting base product can be chilled to less than about 7° C. (45° F.), or 4-10° C. (40-50° F.) and transferred to a refrigerated holding tank.

In certain embodiments, the base product can be aged by holding at about 7° C. (45° F.), or 4-10° C. (40-50° F.) prior to freezing. The base product may be aged for at least about 1 hr, or at least about 2 hrs, or at least about 3 hrs, or at least about 4 hrs, or from about 4-12 hrs at about 7° C. (45° F.), or 4-10° C. (40-50° F.).

In further embodiments, freezing of the base product can be preceded by adding flavorings and fine additives such as cinnamon, vanilla bean particles, and sea salt, for example, to the frozen confection base in a flavor tank. Inclusions can be incorporated including, for example, pieces, chips, chunks, and varigates, while continuously freezing the frozen confection base at approximately −6° C. to −5° C. (22° F.) and a 40-150% overrun. A target fill weight can be 350 g. Filling can be into a pint container. The product can be blast frozen to harden prior to shipping. All products can be stored and shipped frozen.

### Protein Component

Herein, “protein” refers to a chain or polymer of amino acids, covalently joined by peptide bonds. Herein, proteins are generally non-animal proteins. Generally, proteins used in the frozen confections containing non-animal proteins described herein are from plants. Proteins from any plant may be used in the frozen confections described herein. Various plant proteins used may be from almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat, white bean, yellow pea and others. In some examples, proteins used in the frozen confections are from legumes. Plant proteins may be from one type of plant or from multiple plants. Other suitable plant protein isolates are also acceptable. In some examples, the plant protein component may include gluten as part of the plant protein. In some examples, the frozen confections disclosed here do not contain gluten.

In some examples, frozen confections disclosed herein may contain proteins from only one plant protein source. In some examples, the frozen confections may contain proteins from one, or from 2, 3, 4, 5, 6, 7, 8, 9 or 10 plant protein sources.

In some examples, specific sources of plant proteins may be excluded from the plant proteins used in the frozen confections disclosed herein. In some examples, plant proteins from one, or from 2, 3, 4, 5, 6, 7, 8, 9, 10 sources may be excluded from the frozen confections disclosed herein. In some examples, plant proteins from one, or more or all of the following plants may be specifically excluded: almond, barley, canola, carrot, cabbage, celery, cereal, chickpea, coconut, emmer, fennel, flax, fava bean, garbanzo bean, lettuce, lupin seeds, melon, mushroom, navy bean, oat, pea, pear, potato, quinoa, rapeseed, rice, sesame, soybean, sunflower, wheat and white bean.

In some such examples, the protein may be from a legume. Generally, any edible legume may be used as a source of protein. In some examples, proteins from one or more specific legumes may be excluded.

In some examples, legumes may include aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans, yuba yellow indian women beans, and others.

In some examples, plant proteins from one, or more or all of the following legumes may be specifically excluded from the frozen confections disclosed herein: aburaage, adzuki beans, alfalfa, anasazi beans, asparagus beans, awase miso, azufrado beans, barley miso, bayo beans, beans, bean curd skin, black adzuki beans, black beans, black chickpeas, black kidney beans, black nightfall beans, black valentines beans, black lentils, black soybeans, black turtle beans, bolita beans, bonavist beans, borlotti beans, bountiful beans, brown lentils, brown speckled cow beans, broad beans, butter beans, calypso beans, canary beans, cannellini beans, carob, chickpeas, christmas lima beans, climbing French beans, clover, cowpeas, crab eye beans, dark red kidney beans, dwarf peas, English peas, European soldier beans, eye of goat beans, fava beans, fayot, flageolet beans, garden peas, great norther beans, hyacinth bean, inariage, Jackson wonder lima bean, kidney bean, kinugoshi, koya-dofu, lablab, lentils, licorice, lima beans, lingot beans, lupins, lupin seeds, Maine yellow eye beans, mayocoba beans, mesquite, molasses face beans, mortgage lifter beans, mung beans, natto, navy beans, okara, ocra beans, otebo beans, peanuts, peas, pigeon peas, pink beans, pink lentils, pinto beans, potato beans, puy lentils, rattlesnake beans, red beans, red eye beans, red lentils, red miso, roman beans, salugia beans, scarlet runner beans, shelling peas, small red beans, small white beans, snow peas, sourthern peas, soybeans, Steuben yellow beans, sugar snap peas, tamarind, tempeh, tongue of fire beans, trout beans, turtle beans, usuage, vallarta beans, vaquero beans, winged beans, yellow lentils, yellow miso, yin yang beans and yuba yellow indian women beans, and others.

In some examples, the protein may be hypoallergenic or non-allergenic protein. Of note is that pea protein is not among the 8 significant food allergens recognized in the United States, which include milk, eggs, fish, crustacean shellfish, tree nuts, peanuts, wheat and soybeans. Pea protein is not among the 14 significant food allergens recognized in Europe. One example hypoallergenic/non-allergenic protein, therefore, includes protein sourced from pea. In some examples, the hypoallergenic or non-allergenic protein may be sourced from hemp, chia, spirulina, quinoa, teff, amaranth, buckwheat and millet. Other hypoallergenic/non-allergenic plant proteins are known in the art.

In some examples, the protein may be lupine protein, including pea or yellow pea. The pea may be whole pea or a component of pea, standard pea (i.e., non-genetically modified pea), commoditized pea, genetically modified pea, or combinations thereof. In some examples, the pea may be Pisum sativum.

In some examples, the frozen confections disclosed herein may contain no other protein or no other plant protein, except protein from peas or protein from yellow peas. In some examples, the frozen confections disclosed herein may contain no other protein or no other plant protein, except protein from Pisum sativum.

In some examples, the protein may be from soy. The soy may be whole soy or a component of soy, standard soy (i.e., non-genetically modified soy), commoditized soy, genetically modified soy, or combinations thereof.

In some examples, the protein may be from chickpea. The chickpea may be whole chickpea or a component of chickpea, standard chickpea (i.e., non-genetically modified chickpea), commoditized chickpea, genetically modified chickpea, or combinations thereof.

In some examples, the protein may be from one or more microbes, including yeast.

Plant protein (e.g., isolated protein) may contain components that negatively affect taste, texture and/or other properties of frozen confections made using the protein. In some examples, the isolated protein preparation may be processed for various purposes, such as to remove components like aroma agents, coloring agents, flavoring agents and other components. In some examples, the protein may be extracted in a solvent to remove lipids and/or heat treated to remove volatiles. Examples of treatments to obtain refined protein are described in the next section of this application.

In some examples, the refined protein may have an aqueous solubility of about 50, 45, 40, 35, 30, 25, 20, 15, 10, 9, 8, 7, 6, 5, 4, 3, 2 or 1 percent (w/w). In some examples, the refined protein may have an aqueous solubility of no more than or less than about 15, 14, 13, 12, 11, 10, 9, 8, 7, 6, 5, 4, 3, 2 or 1 percent (w/w).

Herein, pH of protein preparations is determined by dissolving protein in water to obtain a 10% (w/w) solution and then determining pH of the solution (i.e., solution pH). In some examples, the refined protein may have a solution pH of about or less than about or no more than 8.0, 7.9, 7.8, 7.7, 7.6, 7.5, 7.4, 7.3, 7.2, 7.1, 7.0, 6.9, 6.8, 6.7, 6.6, 6.5, 6.4, 6.3, 6.2, 6.1, 6.0, 5.9, 5.8, 5.7, 5.6, 5.5, 5.4, 5.3, 5.2, 5.1, 5.0, 4.9. 4.8, 4.7, 4.6, 4.5, 4.4, 4.3, 4.2, 4.1, 4.0, 3.9, 3.8, 3.7, 3.6, 3.5, 3.4, 3.3, 3.2, 3.1, 3.0, 2.9, 2.8, 2.7, 2.6, 2.5, 2.4, 2.3, 2.2, 2.1 or 2.0. Generally, the solution pH of the precipitated protein is acidic. In some examples, the refined protein may have a solution pH of about 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8. In some examples, the refined protein may have a solution pH of less than about 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8. In some examples, the refined protein may have a solution pH in the range of about 2.0-3.0, 2.0-3.5, 2.0-4.0, 2.0-4.5, 2.0-5.0, 2.0-5.5, 2.0-6.0, 2.0-6.5, 2.5-3.0, 2.5-3.5, 2.5-4.0, 2.5-4.5, 2.5-5.0, 2.5-5.5, 2.5-6.0, 2.5-6.5, 3.0-3.5, 3.0-4.0, 3.0-4.5, 3.0-5.0, 3.0-5.5, 3.0-6.0, 3.0-6.5, 3.5-4.0, 3.5-4.5, 3.5-5.0, 3.5-5.5, 3.5-6.0, 3.5-6.5, 4.0-4.5, 4.0-5.0, 4.0-5.5, 4.0-6.0, 4.0-6.5, 4.5-5.0, 4.5-5.5, 4.5-6.0, 4.5-6.5, 5.0-5.5, 5.0-6.0, 5.0-6.5 or 6.0-6.5.

In some examples, the refined protein may have a sodium content of about or less than about or no more than 8000, 7500, 7000, 6500, 6000, 5500, 5000, 4900, 4800, 4700, 4600, 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 11700, 1600, 1500, 1400, 1300, 1200, 1100, 1000, 950, 940, 930, 920, 910, 900, 890, 880, 870, 860, 850, 840, 830, 820, 810, 800, 790, 780, 770, 760, 750, 740, 730, 720, 710, 700, 690, 680, 670, 660, 650, 640, 630, 620, 610, 600, 590, 580, 570, 560, 550, 540, 530, 520, 510, 500, 490, 480, 470, 460, 450, 440, 430, 420, 410, 400, 390, 380, 370, 360, 350, 340, 330, 320, 310, 300, 290, 280, 270, 260, 250, 240, 230, 220, 210, 200, 190, 180, 170, 160, 150, 140, 130, 120, 110, 100, 90, 80, 70, 60, 50, 40, 30, 20 or 10 parts per million (ppm).

The refined protein preparation may have various forms, including, but not limited to concentrate, flour, isolate, meal, paste, powder and others. The protein may be native, denatured or renatured; dried, spray dried, or not dried protein; enzymatically treated, chemically treated or untreated protein; and combinations thereof. The protein may consist of particles of one or more sizes and may be pure or mixed with other components (e.g., other plant source components).

In some examples, proteins processed by specific methods may be excluded from the frozen confections disclosed herein. In some examples, proteins having specific forms (e.g., concentrate, flour, isolate, meal, paste, powder) may be excluded from the frozen confections disclosed herein. In some examples, proteins that are denatured, renatured; dried, spray dried; enzymatically treated; of specific sizes; and/or mixed with other components, may be specifically excluded from the frozen confections disclosed herein.

In some examples, the processed or refined protein may contain at least 10, 20, 30, 40, 50, 60, 70, 80 or 90% by weight of protein. The processed or refined protein may contain a percent by weight of protein of between 10-30, 10-20, 12-16, 20-99, 20-60, 25-95, 30-90, 30-50, 40-99, 40-95, 40-90, 40-85, 40-80, 40-75, 50-99, 50-95, 50-90, 50-85, 50-80, 60-99, 60-95, 60-90, 60-85, 60-80, 60-75, 65-99, 65-95, 65-90, 65-85, 65-80, 70-99, 70-95, 70-90, 70-85, 70-80, 75-99, 75-95, 75-90, 75-85, 75-80 and others.

In some examples, the processed/refined protein may contain carbohydrates and/or fat. In some examples, the processed/refined protein may contain calcium, phosphorous, potassium, sodium, and other cations. In some examples, the processed/refined protein may contain ash.

In some examples, the frozen confections disclosed herein may specifically exclude one or more cations and/or ash.

In some examples, the refined protein may have a carbohydrate content of between 0-50% by weight. In some examples, the refined protein may have a carbohydrate content of at least 0% by weight. In certain examples, the refined protein may have a carbohydrate content of less than 25% by weight. In some examples, no carbohydrate may be present in the refined protein.

In some examples, the refined protein may have a starch content of between 0-10% by weight. In some examples, the refined protein may have a starch content of at least 3% by weight. In some examples, the refined protein may have a starch content of less than 9% by weight. In some examples, no starch may be present in the refined protein.

In some examples, the refined protein may have a fat content of between 1-30% by weight. In some examples, the refined protein may have a fat content of at least 2% by weight. In some examples, the refined protein may have a fat content of less than 25% by weight. In some examples, no fat may be present in the refined protein.

In some examples, the refined protein may have a calcium content of between 0-5% by weight. In some examples, the calcium content may be between about 0.1 and 2% by weight. In some examples, no calcium may be present in the refined protein.

In some examples, the refined protein may have a phosphorus content of between 0-6% by weight. In some examples, the phosphorus content may be at least 0.1% by weight. In some examples, the refined protein may have a phosphorus content of less than 4% by weight. In some examples, no phosphorus may be present in the refined protein.

In some examples, the refined protein may have a potassium content of less than 0.5% by weight. In some examples, no potassium may be present in the refined protein.

In some examples, the refined protein may have an ash content of between 0-20% by weight. In some examples, the refined protein may have an ash content of at least 1% by weight. In some examples, no ash may be present in the refined protein.

In some examples, the refined protein may be in the form of granules. In some examples, the refined protein may be in the form of a powder. In some examples, the refined protein may be in the form of a granulated powder. In some examples, the refined protein may be a flour. In some examples, the size of particles or the mean size of particles in these forms of refined protein may be between 1 and 1000 μm, 10 and 500 μm, 50 and 350 μm, 70 and 250 μm or 100 and 150 μm. In some examples, the mean size of particles in a distribution of the particles may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size. In some examples, at least 10, 20, 30, 40, 50, 60, 70, 80, 90 or 95% of the particles these forms of refined protein may be about 0.1, 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000 μm in size.

In some examples, a particle size distribution for the protein particles may be D×50 of about or less than about 200, 190, 180, 170, 160, 150, 140, 130, 120, 110, 100, 90, 80, 70, 60, 50, 40, 30, 20 or 10 μm.

In some examples, adsorption of water, the amount of water adsorbed, the rate at which water is adsorbed, and the like, may be affected by the size of the protein particles. In some examples, things like the amount and/or rate of water adsorption may be related to or proportional to the surface area, volume, surface area per unit volume, and the like, of the protein particles (e.g., granules, powder, granulated powder). In some examples, this may not be the case.

The protein preparations used herein may have some binder activity. The protein preparations used herein may have some emulsifier activity.

In some examples, at least some of the protein in the disclosed frozen confections may be from eggs. In some examples, the frozen confections disclosed herein may not contain eggs. In some examples, the frozen confections disclosed herein may specifically exclude egg protein.

In some embodiments, a composition may contain a pea protein isolate and/or refined pea protein.

A pea protein isolate and/or refined plant protein used in this invention may be a neutral color, refined protein component obtained from non-animal, natural sources. A pea protein isolate and/or refined plant protein can be extracted from a protein preparation derived from non-animal, natural sources.

A protein isolate and/or refined plant protein can be a protein material that is obtained from a natural source upon removal of some of the following: insoluble polysaccharides, fibers, soluble carbohydrates, and ash. A protein isolate and/or refined plant protein can have about 70-90% by weight of protein. A protein isolate can have about 5-95% by weight of protein. A protein isolate and/or refined plant protein can have about 5%, 10%, 20%, 30%, 40%, 50%, 60%, 70%, 80%, or 90% by weight of protein.

In some embodiments, a neutral color, refined protein component can be a protein preparation that has a color that is defined by a lightness value of about 60-90, and a red/green value of about −20 to 20, and a yellow/blue value of about −30 to 30 (CIELAB color system).

Protein content of a food product may be determined by a methods such as AOAC International reference methods (AOAC 990.03 and AOAC 992.15), as well as combustion analysis (ISO 14891:2008).

In some aspects, a plant protein and/or refined plant protein can be derived from a legume, a tuber, a grain, or an oil seed.

Examples of a refined protein component containing a pea protein isolate include Ripptein®.

Examples of a legume suitable to provide a plant protein, isolated plant protein and/or refined plant protein for a composition of this invention include pea, lentil, lupini bean, chickpea, faba bean, soy bean, peanut, bean, alfalfa, clover, fava coceira, frijole bola roja, frijole negro, lespedeza, licorice, mesquite, carob, tamarind, wisteria, cassia, fenugreek, green pea, yellow pea, snow pea, lima bean, black bean, baby bean, and combinations thereof.

For example, faba bean is also known as Vicia faba, broad bean, and fava bean.

Examples of a legume suitable to provide a plant protein, isolated plant protein and/or refined plant protein for a composition of this invention include alfalfa, asparagus bean, asparagus pea, baby lima bean, black bean, black-eyed pea, black turtle bean, Boston bean, Boston navy bean, broad bean, cannellini bean, carob, cassia, chickpea, chili bean, cranberry bean, dwarf bean, Egyptian bean, Egyptian white broad bean, English bean, fava bean, fava coceira, fenugreek, field pea, french green bean, frijol bola roja, frijole negro, great northern bean, green pea, kidney bean, lentil, lespedeza, licorice, lima bean, lupini bean, Madagascar bean, mesquite, Mexican black bean, Mexican red bean, molasses face bean, mung bean, mung pea, mungo bean, navy bean, pea bean, peanut, Peruvian bean, pinto bean, red bean, red clover, red eye bean, red kidney bean, rice bean, runner bean, scarlet runner bean, small red bean, snow pea, southern pea, sugar snap pea, soy bean, tamarind, wax bean, white vlover, white kidney bean, white pea bean, wisteria, yellow pea, and combinations thereof.

Examples of a tuber suitable to provide a plant protein, isolated plant protein and/or refined plant protein for a composition of this invention include potato, sweet potato, cassava, yam, taro, canna, arrowroot, and combinations thereof.

Examples of a grain suitable to provide a plant protein, isolated plant protein and/or refined plant protein for a composition of this invention include quinoa, sorghum, oat, wheat, spelt, teff, rice, corn, and combinations thereof.

Examples of an oil seed suitable to provide a plant protein, isolated plant protein and/or refined plant protein for a composition of this invention include sunflower, flax, canola, cottonseed, hemp, chia, and combinations thereof.

Examples of plant sources include flax, sunflower, oat, canola, yellow pea, garbanzo bean, fava bean, white bean, navy bean, soybean, sesame, quinoa, and combinations thereof.

Examples of sources of some proteins from which an isolate or refined protein could be derived, without limitation, include:

Pea Protein Isolate S85F (Roquette);

Puris Pea 870 (Cargill);

Pea Protein Isolate 80 (Nutralliance);

Soyprotein isolate (Soy PI, Now Sports);

Examples of sources of some proteins from which an isolate or refined protein could be derived, without limitation, include:

Yellow pea flour (Ingredion 1102);

Garbanzo bean flour (Bob's Red Mill);

Fava bean flour (Bob's Red Mill);

White bean flour (Bob's Red Mill);

Navy bean flour (Bob's Red Mill);

Low fat soy flour (Bob's Red Mill);

Defatted sesame flour (Sukrin); and

Defatted almond flour (Sukrin).

### Processes for Preparing Refined Plant Protein

Various methods may be used for obtaining refined protein components from non-animal natural protein sources. The refined protein components may be used in the frozen confections disclosed herein. However, isolated protein or non-refined protein components may also be used, exclusively or in combination with refined protein components.

Generally, the methods described below may remove or substantially remove components that may affect flavor, aroma, color and so on, from protein preparations, and thus make the refined protein preparations more suitable for use in the disclosed frozen confections. Removal of such agents may also increase the shelf life of frozen confections comprising such refined protein components.

In some examples, methods for obtaining refined protein components from non-animal natural sources may comprise one or more of the following steps, in or out of order:

a) obtaining a protein preparation from a non-animal natural source;

b) washing the protein preparation at a wash pH;

c) extracting the protein preparation at an extraction pH to obtain an aqueous protein solution;

d) separating the aqueous protein solution from non-aqueous components;

e) optionally, adding salt;

f) precipitating the protein from the aqueous protein solution at a precipitation pH to obtain a protein precipitate;

g) separating the protein precipitate from non-precipitated components; and

h) washing the protein precipitate to obtain a refined protein component.

Generally, it is at least steps (e) and (f) above that are used to prepare what is called herein as “salt-precipitated protein.” In some examples, protein is precipitated without added salt, however. Additional steps may also be included in the process.

In some examples, the extraction and precipitation steps may be performed under heated conditions (e.g., between 50-70 or 60-70° C.). In some examples, at least steps (c) and/or (f) are performed at these temperatures. In some examples, steps (c) though (g) are performed at these temperatures. In some examples, steps (a) through (f) may be performed at these temperatures.

Washing the refined protein preparation may utilize various methods, including single wash, multiple washes, and/or counter-current washes.

The extraction pHs may be pHs that are suitable for washing and solubilizing proteins in a protein preparation. A suitable extraction pH may be determined by testing various pH conditions, and identifying the pH condition at which the most optimal yield and quality (judged by, for example by one or more of the following: flavor, odor, color, nitrogen content, calcium content, heavy metal content, emulsification activity, molecular weight distribution, and thermal properties of the protein component obtained) of the refined protein component is obtained. In some examples, the extraction pH is an alkaline pH. In some such examples, the alkaline pH is at least 7.1, at least 8, at least 9, at least 10, at least 11, at least 12, between 7.1 and 10, between 8 and 10, between 9 and 10, or between 8 and 9. In some such examples, the alkaline pH is 8.5. In some examples, the extraction pH may be an acidic pH. In some such examples, the acidic pH is less than 7, less than 6.95, less than 6.5, less than 5, less than 4, less than 3, between 2 and 6.95, between 3 and 6, or between 3 and 5. The extraction pH may be adjusted using a pH adjusting agent. In some examples, the pH adjusting agent is a food grade basic pH adjusting agent. In other examples, the pH adjusting agent is a food grade acidic pH adjusting agents. Examples of suitable acidic pH adjusting agents include, but are not limited to, phosphoric acid, acetic acid, hydrochloric acid, citric acid, succinic acid, and combinations thereof. Examples of suitable basic pH adjusting agents include, but are not limited to, potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. It may be useful to obtain substantially as much extracted protein as is practicable so as to provide an overall high product yield. The yield of protein in the aqueous protein solution may vary widely, wherein typical yields range from 1% to 90%. The aqueous protein solution typically has a protein concentration of between 1 g/L and 300 g/L. The molecular weight distribution of the proteins comprised in the aqueous protein solution may vary widely.

Separating the aqueous protein solution from non-aqueous components may be accomplished by various methods, including but not limited to, centrifugation followed by decanting of the supernatant above the pellet, or centrifugation in a decanter centrifuge. The centrifugation may be followed by disc centrifugation and/or filtration (e.g., using activated carbon) to remove residual protein source material and/or other impurities. The separation step may be conducted at various temperatures within the range of 1° C. to 100° C. For example, the separation step may be conducted between 10° C. and 80° C., between 15° C. and 70° C., between 20° C. and 60° C., or between 25° C. and 45° C. The non-aqueous components may be re-extracted with fresh solute at the extraction pH, and the protein obtained upon clarification combined with the initial protein solution for further processing as described herein. The separated aqueous protein solution may be diluted or concentrated prior to further processing. Dilution is usually affected using water, although other diluents may be used. Concentration may be affected by membrane-based methods. In some examples, the diluted or concentrated aqueous protein solution comprises between 1 g/L and 300 g/L, between 5 g/L and 250 g/L, between 10 g/L and 200 g/L, between 15 g/L and 150 g/L, between 20 g/L and 100 g/L, or between 30 g/L and 70 g/L by weight of protein.

The protein in the aqueous protein solution may be optionally concentrated and/or separated from small, soluble molecules. Suitable methods for concentrating include, but are not limited to, diafiltration or hydrocyclonation. Suitable methods for separation from small, soluble molecules include, but are not limited to, diafiltration.

Salt precipitation may be accomplished using various suitable salts and precipitation pH. Suitable salts, salt concentrations, polysaccharides, polysaccharide concentrations, and precipitation pHs may be determined by testing various conditions and identifying the salt and pH and polysaccharide conditions which obtain the most colorless and/or flavorless protein precipitates at the most optimal yield and quality (judged by, for example, by one or more of the following: flavor, odor, color, nitrogen content, calcium content, heavy metal content, emulsification activity, molecular weight distribution, and thermal properties of the protein component obtained). In some examples, salt precipitation occurs with calcium dichloride at a concentration of between 5 mM and 1,000 mM. Other examples of suitable salts include, but are not limited to, other alkaline earth metal or divalent salts (e.g., magnesium chloride, sodium chloride, calcium permanganate, and calcium nitrate). In some examples, salt is not used (e.g., the precipitation is performed at the precipitation pH without adding salt).

Typically, the precipitation pH is opposite the extraction pH (i.e., when the extraction pH is in the basic range, the precipitation pH is most suitable in the acidic range, and vice versa). In some examples, the precipitation pH may be alkaline or neutral. In some examples, the precipitation pH is an acidic pH. In some such examples, the acidic pH is less than 7.1, less than 6, less than 5, less than 4, less than 3, less than 2, between 6.9 and 2, between 6 and 3, between 6 and 5, or between 5 and 4. In some such examples, the acidic pH is 5.25. In some examples, the precipitation pH is about or less than about 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7 or 6.8. In some examples, a precipitation pH in the case where salt is included in the process step may be about 4.0-4.7. In some examples, a precipitation pH where salt is not included in the process step may be about 4.9.

The precipitation pH may be adjusted using a pH adjusting agent. In some examples, the pH adjusting agent may include phosphoric acid. In some examples, the pH adjusting agent is a food grade acidic pH adjusting agent. In other examples, the pH adjusting agent is a food grade basic pH adjusting agent.

Separating the protein precipitate from non-precipitated components may occur by one or more of the methods disclosed herein.

Washing of the protein precipitate may occur by various methods. In some examples, the washing is carried out at the precipitation pH (e.g., if the protein is precipitated at an acid pH, the protein is washed at the acid pH and is not neutralized by a washing step). In some examples, the protein precipitate may not be washed.

The protein precipitate may optionally be suspended. In some examples, the suspending is carried out at the extraction pH, for example, in the presence of a chelator to remove calcium ions. If the suspended protein preparation is not transparent it may be clarified by various convenient procedures such as filtration or centrifugation.

The pH of the suspended color-neutral refined protein component may be adjusted to a pH of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The refined protein component may be dried. Drying may be performed in a suitable way, including, but not limited to, spray drying, dry mixing, agglomerating, freeze drying, microwave drying, drying with ethanol, evaporation, refractory window dehydration or combinations thereof.

Other optional steps in the exemplary methods are heating steps aimed at removing heat-labile contaminants and/or microbial contaminations, and additional filtering (e.g., carbon filtering) steps aimed at removing additional odor, flavor, and/or color compounds. In some examples, such additional filtering is carried out immediately after extracting the protein preparation or after separating the aqueous protein solution from the non-aqueous components.

### Amounts of Protein in Frozen Confections

In some examples, the disclosed frozen confections are made with unrefined/non-refined proteins from plants. In some examples, the frozen confections made with processed/refined proteins from plants (e.g., salt-precipitated protein). In some examples, both refined protein (e.g., salt-precipitated or non-salt-precipitated acidic protein) and protein that is not refined may be used.

In some examples, the protein may be from a single source. In some examples, the protein may be from 2, 3, 4, 5, 6, 7, 8, or 10 separate sources. In some examples, the proteins are from plant sources.

In some examples, the protein may be included as an ingredient of the disclosed frozen confections at amounts that are about 1, 2, 3, 4, 5, 6, 7, 8, 9, 10, 11, 12, 13, 14, 15, 16, 17, 18, 19 or 20 percent by weight.

In some examples, protein may be included at amounts between about 1-2, 1-3, 1-4, 1-5, 1-6. 1-7, 1-8, 1-9, 1-10, 1-11, 1-12, 1-13, 1-14, 1-15, 1-16, 1-17, 1-18, 1-19, 1-20, 2-3, 2-4, 2-5, 2-6. 2-7, 2-8, 2-9, 2-10, 2-11, 2-12, 2-13, 2-14, 2-15, 2-16, 2-17, 2-18, 2-19, 2-20, 3-4, 3-5, 3-6. 3-7, 3-8, 3-9, 3-10, 3-11, 3-12, 3-13, 3-14, 3-15, 3-16, 3-17, 3-18, 3-19, 3-20, 4-5, 4-6. 4-7, 4-8, 4-9, 4-10, 4-11, 4-12, 4-13, 4-14, 4-15, 4-16, 4-17, 4-18, 4-19, 4-20, 5-6. 5-7, 5-8, 5-9, 5-10, 5-11, 5-12, 5-13, 5-14, 5-15, 5-16, 5-17, 5-18, 5-19, 5-20, 6-7, 6-8, 6-9, 6-10, 6-11, 6-12, 6-13, 6-14, 6-15, 6-16, 6-17, 6-18, 6-19, 6-20, 7-8, 7-9, 7-10, 7-11, 7-12, 7-13, 7-14, 7-15, 7-16, 7-17, 7-18, 7-19, 7-20, 8-9, 8-10, 8-11, 8-12, 8-13, 8-14, 8-15, 8-16, 8-17, 8-18, 8-19 or 8-20 percent by weight.

### Sweetener Component

In some embodiments, a composition may contain one or more sweetener components. In some examples, the sweetening agents may be carbohydrates, sugars for example. In some examples, the sweetening agents may not be carbohydrates. Example sweetening agents are known in the art. Some exemplary sweetening agents may include glycerin, erythritol, stevia, monk fruit, and others. Individual sweetening agents may be used individually or in combination.

Carbohydrate content of a food product may be determined by methods such as high-performance liquid chromatography (HPLC).

Examples of a sweetener suitable for a composition of this invention include sugar cane, sugar beet, agave, corn, monk fruit, stevia, and combinations thereof.

Examples of sweeteners include glucose, sucrose, allulose, fructose, dextrose, maltose, dextrin, maltodextrin, sucralose, levulose, tagatose, galactose, corn syrup and combinations thereof.

Examples of natural sweeteners include agave, cane juice, corn syrup, honey, maple syrup, stevia, and combinations thereof.

Examples of sugarless sweeteners include sugar alcohols, maltitol, xylitol, sorbitol, erythritol, mannitol, isomalt, lactitol, and combinations thereof.

In some examples, sweetening agents may be present in the frozen confections at levels that are about, less than about, or greater than about 2, 2.5, 3.0, 3.5, 4.0, 4.5, 5.0, 5.5, 6.0, 6.5, 7.0, 7.5, 8.0, 9.5, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 25.5, 26.0, 26.5, 27.0, 27.5, 28.0, 28.5, 29.0, 29.5 or 30.0 percent by weight.

In some examples, the sweetener or sweetening agent may be present in the frozen confections at levels that are between about 8-12, 8-13, 8-14, 8-15, 8-16, 8-17, 8-18, 8-19, 8-20, 8-21, 9-12, 9-13, 9-14,9-15, 9-16, 9-17, 9-18, 8-19, 9-20, 9-21, 10-12, 10-13, 10-14, 10-15, 10-16, 10-17, 10-18, 10-19, 10-20, 10-21, 11-12, 11-13, 11-14, 11-15, 11-16, 11-17, 11-18, 11-19, 11-20, 11-21, 12-13, 12-14, 12-15, 12-16, 12-17, 12-18, 12-19, 12-20, 12-21, 13-14, 13-15, 13-16, 13-17, 13-18, 13-19, 13-20, 13-21, 14-15, 14-16, 14-17, 14-18, 14-19, 14-20, 14-21, 15-16, 15-17, 15-18, 15-19, 15-20, 15-21, 16-17, 16-18, 16-19, 16-20, 16-21, 17-18, 17-19, 17-20, 17-21, 18-19, 18-20, 18-21, 19-20, 19-21 or 20-21 percent by weight. In some examples, the frozen confections disclosed herein may contain no sweetening agents.

### Emulsifier Component

In some embodiments, a composition may contain one or more emulsifier components. Herein, emulsifiers are substances that stabilize emulsions. Generally, emulsifiers used in the disclosed frozen confections may be emulsifiers commonly used for oil in water emulsions in food products.

In certain embodiments, an emulsifier may comprise two or more gums.

Examples of an emulsifier include starches, lecithins, mono- and diglycerides, propyleneglycol monoesters, and combinations thereof. Examples of emulsifiers include gums, xanthan gum, bean gum, guar gum, gum arabic, gum ghatti, gum karaya, gum tragacanth, gellan gum, hydrocolloids, acacia, locust bean gum, xanthan, gellan, carrageenan, cellulose gum, cellulose gel, carboxymethyl cellulose, microcrystalline cellulose, methylcellulose, hydroxypropyl methyl cellulose, hydroxypropylcellulose, pectin, gelatin, agar, furcellaran, dextran, beta-glucan, dammar gum, glucomannan, mastic gum, psyllium seed husks, tara gum, quillaia gum, gum Arabic, carob gum and combinations thereof.

In some examples, gums may have thickening agent and/or stabilizing agent activity. In some examples, these agents may include a “high acyl gellan gum.” High acyl gellan gum, as used herein, is a polymer comprising various monosaccharides linked together to form a linear primary structure and the gum gels at temperatures of greater than 60° C. The properties of the high acyl gellan gum polymer may vary depending at least in part on its source, how it was processed, and/or the number and type of acyl groups present on the polymer.

Gellan gum is a gel-forming polysaccharide produced by the microbe Sphingomonas elodea. There are several sources of suitable high acyl gellan gums, for example, Ticagel Gellan HS, TIC gums, KELCOGEL High Acyl Gellan Gum, CP Kelco, Gellan Gum LT100 and Modernist Pantry. Gellan polymers typically consist of monosaccharides beta-d-glucose, beta-d-glucuronic acid and alpha-1-rhamnose in approximate molar ratios of 2:1:1 linked together to form a linear primary structure.

In some examples, the thickening agent may include xanthan gum.

In some examples, the emulsifiers used may be lecithins. Lecithins may be from a variety of sources. Generally, the lecithins used herein are from non-animal sources. The lecithins used herein may be from plant sources. In some examples, the lecithins used herein are de-oiled lecithins. Example plant-based lecithins may be from canola, coconut, corn, cottonseed, rapeseed, soy, sunflower and other plants.

Generally, the emulsifiers are used in amounts that stabilize an emulsion. In some examples, emulsifiers may be present in the frozen confections at about, less than about, or greater than about 0.01, 0.02, 0.03, 0.04, 0.05, 0.06, 0.07, 0.08, 0.09, 0.10, 0.12, 0.14, 0.16. 0.18, 0.20, 0.22, 0.24, 0.26, 0.28, 0.3, 0.32, 0.34, 0.36, 0.38, 0.40, 0.42, 0.44, 0.46, 0.48, 0.50, 0.52, 0.54, 0.56, 0.58, 0.6, 0.62, 0.64, 0.66, 0.68, 0.70, 0.75, 0.80, 0.82, 0.84, 0.86, 0.88, 0.90, 0.92, 0.94, 0.96, 0.98, 1.0, 1.1, 1.2, 1.3, 1.4, 1.5, 1.6, 1.7, 1.8 1, 9, 2.0, 2.1, 2.2, 2.3, 2.4, 2.5, 2.6, 2.7, 2.8, 2.9 or 3.0 weight percent.

In some examples, the frozen confections may contain no emulsifiers, may contain no emulsifiers in addition to other ingredients that may have emulsification activity.

### Texturizer Component

In some embodiments, a composition may contain one or more texturizer components. In some examples, texturizers act by swelling in water such that there is less free-flowing water in a product, causing viscosity to increase.

Examples of a texturizer include sugars, fiber, maltodextrin, inulin, fructo oligosaccharides, pectin, carboxymethyl cellulose, guar gum, corn starch, oat starch, potato starch, rice starch, wheat starch, amaranth flour, oat flour, quinoa flour, rice flour, rye flour, sorghum flour, soy flour, wheat flour, corn flour, barley bran, carrot fiber, citrus fiber, corn fiber, corn bran, soluble dietary fiber, insoluble dietary fiber, oat bran, pea fiber, rice bran, head husks, soy fiber, soy polysaccharide, wheat bran, wood pulp cellulose, inulin, psyllium, oligofructose, galacto-oligosaccharides, fibers, citrus fiber, and combinations thereof.

### Flavorants

In some embodiments, a composition may contain one or more flavorant components or flavoring agents.

Examples of flavorants include salts, sodium citrate, sodium chloride, potassium citrate, potassium phosphate, dipotassium phosphate, and combinations thereof.

Examples of flavorants include taste modifiers known in the art.

Examples of flavorants include natural flavorants as known in the art.

Examples of flavorants include taste modifiers such as TASTEGEM and TastePRINT™ (Firmenich), TasteEssentials® (Givaudan) and TasteSolutions® (Givaudan), and combinations thereof.

Examples of flavorants include components derived from honey, vanilla, chocolate (cocoa), fruit, blueberry, strawberry, raspberry, mango, citrus, lemon, orange, coconut, passion fruit, peach, mint and combinations thereof.

In some examples, the flavorants may include sodium chloride, sea salt, sodium citrate, potassium citrate, potassium phosphate, dipotassium phosphate, cinnamon and combinations thereof

### pH Control

In some embodiments, the pH of a composition or product can be adjusted. In some examples, one or more acidifiers (e.g., acids) or deacidifiers (e.g., bases) may be used to adjust pH.

Examples of components that may be used to control or adjust pH include acetic acid, hydrochloric acid, phosphoric acid, citric acid, tartaric acid, malic acid, glucono, gluconic acid, disodium diphosphate, potassium hydroxide, sodium hydroxide, sodium phosphate, potassium phosphate, and combinations thereof.

In some examples, the frozen confections may contain one or more deacidifiers. Generally, the deacidifiers may decrease the acidity/increase the pH of a food product. In some examples, such a deacidifier may include potassium hydroxide. In some examples, a deacidifier may be used at an amount at about or up to about 0.1, 0.2, 0.3, 0.4, 0.5, 0.6, 0.7, 0.8, 0.9, 1.0, 1.1, 1.2, 1.3, 1.4 or 1.5 weight percent.

### Oil Component

In some embodiments, a composition may contain one or more oil components.

A compositions for making a frozen confection may contain one or more of coconut oil, soybean oil, sunflower oil, palm oil, flaxseed oil, oat oil, illipe oil, shea oil, shorea robusta oil, cocoa butter oil, corn oil, aloe vera oil, avocado oil, baobab oil, calendula oil, canola oil, pumpkin oil, cottonseed oil, evening primrose oil, grape seed oil, jojoba oil, neem oil, olive oil, rapeseed oil, sesame oil, and combinations thereof.

Examples of an oil component include almond oil, hazelnut oil, peanut oil, walnut oil, brazil nut oil, cashew oil, pine nut oil, pecan oil, macadamia nut oil, pistachio oil, sacha inchi nut oil, and combinations thereof.

In some embodiments, a product described herein may be substantially free of nuts, nut oil, and/or nut components, wherein coconut is not classified as a nut.

Lipid content of a food product may be determined by methods such as AOAC International AOAC 954.02.

In some examples, oil may be present in the frozen confections at about, less than about, or greater than about 4.0. 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5 or 18.0 weight percent.

In some examples, oil may be present in the frozen confections between about 4-8, 4-9, 4-10, 4-11, 4-12, 4-13, 4-14, 4-15, 4-16, 4-17, 4-18, 5-8, 5-9, 5-10, 5-11, 5-12, 5-13, 5-14, 5-15, 5-16, 5-17, 5-18, 6-8, 6-9, 6-10, 6-11, 6-12, 6-13, 6-14, 6-15, 6-16, 6-17, 6-18, 7-8, 7-9, 7-10, 7-11, 7-12, 7-13, 7-14, 7-15, 7-16, 7-17, 7-18, 8-9, 8-10, 8-11, 8-12, 8-13, 8-14, 8-15, 8-16, 8-17, 8-18, 9-10, 9-11, 9-12, 9-13, 9-14, 9-15, 9-16, 9-17, 9-18, 10-11, 10-12, 10-13, 10-14, 10-15, 10-16, 10-17, 10-18, 11-12, 11-13, 11-14, 11-15, 11-16, 11-17, 11-18, 12-13, 12-14, 12-15, 12-16, 12-17, 12-18, 13-14, 13-15, 13-16, 13-17, 13-18, 14-15, 14-16, 14-17, 14-18, 15-16, 15-17, 15-18, 16-17, 16-18 or 17-18 weight percent.

In some examples, the frozen confections may contain no oil.

### Bulking Component

Generally, bulking components or bulking agents increase the volume and/or weight of a food. In some examples, bulking agents may increase sweetness, while limiting calories. In some examples, bulking components used in the frozen confections may include tapioca syrup, polydextrose, maltodextrin, corn syrup solids, and combinations thereof.

In some examples, bulking components may be present in the frozen confections at about, less than about, or greater than about 4.0. 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, 14.0, 14.5, 15.0, 15.5, 16.0, 16.5, 17.0, 17.5 or 18.0 weight percent.

In some examples, bulking components may be present in the frozen confections between about 4-8, 4-9, 4-10, 4-11, 4-12, 4-13, 4-14, 4-15, 4-16, 4-17, 4-18, 5-8, 5-9, 5-10, 5-11, 5-12, 5-13, 5-14, 5-15, 5-16, 5-17, 5-18, 6-8, 6-9, 6-10, 6-11, 6-12, 6-13, 6-14, 6-15, 6-16, 6-17, 6-18, 7-8, 7-9, 7-10, 7-11, 7-12, 7-13, 7-14, 7-15, 7-16, 7-17, 7-18, 8-9, 8-10, 8-11, 8-12, 8-13, 8-14, 8-15, 8-16, 8-17, 8-18, 9-10, 9-11, 9-12, 9-13, 9-14, 9-15, 9-16, 9-17, 9-18, 10-11, 10-12, 10-13, 10-14, 10-15, 10-16, 10-17, 10-18, 11-12, 11-13, 11-14, 11-15, 11-16, 11-17, 11-18, 12-13, 12-14, 12-15, 12-16, 12-17, 12-18, 13-14, 13-15, 13-16, 13-17, 13-18, 14-15, 14-16, 14-17, 14-18, 15-16, 15-17, 15-18, 16-17, 16-18 or 17-18 weight percent.

In some examples, the frozen confections may contain no bulking components.

### Thickening Agents

Generally, thickening agents refer to substances that increase the viscosity of a liquid. Generally, thickening agents increase viscosity without substantially changing other properties of the liquid. The thickening agents referred to in this application are generally edible thickening agents. In some examples, the thickening agents used herein may dissolve in a liquid as a colloid that forms a cohesive internal structure (e.g., a gel).

Herein, other components of the formulations and/or compositions disclosed herein (e.g., starch, protein) may functionally act to thicken liquid formulations of the baked goods described herein. Generally, the substances described in this section are added to the formulations to provide additional thickening.

Many different types of thickening agents may be used. Generally, any thickening agent that is acceptable for use in a baked good can be used. Usable thickening agents may include polysaccharides, like starches, vegetable gums, pectin and others. Combinations of thickening agents may be used.

In some examples, the thickening agent may be fecula, including almond flour, arrowroot, cornstarch, katakuri starch, potato starch, sago, tapioca, wheat flour and their starch derivatives. Microbial and vegetable gums used as food thickeners may include alginin, guar gum, locust bean gum, xanthan gum and the like. Proteins used as food thickeners may include certain non-dairy proteins. Sugar polymers include may include agar, carrageenan, carboxymethyl cellulose, pectin and the like.

In some examples, the thickening agent may include a “high acyl gellan gum.”

In some examples, the thickening agent(s) may be included in the disclosed baked goods at amounts that are about, at least about, or no greater than about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.5, 2.0, 2.5, 3.0, 3.5, 4.0, 4.5 or 5 percent on a weight basis.

### Solubilizers

The frozen confections may contain one or more solubilizers. In some examples, a solubilizer may be used at an amount at about or up to about 0.1, 0.2, 0.3, 0.4, 0.5, 0.6, 0.7, 0.8, 0.9 or 1.0 weight percent.

### Buffer Component

In some embodiments, a composition may contain one or more buffer components. The buffering components are edible.

Examples of a buffer include monophosphates, diphosphates, sodium mono- and bicarbonates, potassium mono- and bicarbonates, potassium phosphate, dipotassium phosphate, potassium hydrophosphate, sodium bicarbonate, sodium citrate, sodium phosphate, disodium phosphate, sodium hydrophosphate, sodium tripolyphosphate, and combinations thereof.

In some examples, the frozen confection disclosed herein may have a pH of about, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6 or 8.7. In some examples, the frozen confection disclosed herein may have a pH in the range of about 7.0-7.2, 7.0-7.3, 7.0-7.4, 7.0-7.5, 7.0-7.6, 7.0-7.7, 7.0-7.8, 7.0-7.9, 7.0-8.0, 7.0-8.1, 7.0-8.2, 7.0-8.3, 7.0-8.4, 7.1-7.2, 7.1-7.3, 7.1-7.4, 7.1-7.5, 7.1-7.6, 7.1-7.7, 7.1-7.8, 7.1-7.9, 7.1-8.0, 7.1-8.1, 7.1-8.2, 7.1-8.3, 7.1-8.4, 7.2-7.3, 7.2-7.4, 7.2-7.5, 7.2-7.6, 7.2-7.7, 7.2-7.8, 7.2-7.9, 7.2-8.0, 7.2-8.1, 7.2-8.2, 7.2-8.3, 7.2-8.4, 7.3-7.4, 7.3-7.5, 7.3-7.6, 7.3-7.7, 7.3-7.8, 7.3-7.9, 7.3-8.0, 7.3-8.1, 7.3-8.2, 7.3-8.3, 7.3-8.4, 7.4-7.5, 7.4-7.6, 7.4-7.7, 7.4-7.8, 7.4-7.9, 7.4-8.0, 7.4-8.1, 7.4-8.2, 7.4-8.3, 7.4-8.4, 7.5-7.6, 7.5-7.7, 7.5-7.8, 7.5-7.9, 7.5-8.0, 7.5-8.1, 7.5-8.2, 7.5-8.3, 7.5-8.4, 7.6-7.7, 7.6-7.8, 7.6-7.9, 7.6-8.0, 7.6-8.1, 7.6-8.2, 7.6-8.3, 7.6-8.4, 7.7-7.8, 7.7-7.9, 7.7-8.0, 7.7-8.1, 7.7-8.2, 7.7-8.3, 7.7-8.4, 7.8-7.9, 7.8-8.0, 7.8-8.1, 7.8-8.2, 7.8-8.3, 7.8-8.4, 7.9-8.0, 7.9-8.1, 7.9-8.2, 7.9-8.3, 7.9-8.4, 8.0-8.1, 8.0-8.2, 8.0-8.3, 8.0-8.4, 8.1-8.2, 8.1-8.3, 8.1-8.4, 8.2-8.3, 8.2-8.4 or 8.3-8.4.

Generally, the buffers used here have buffering capacity within one or more of the above-listed ranges.

### Additional Nutritional Components

In some embodiments, a composition may contain one or more nutritional components.

In certain embodiments, a frozen confection may be fortified with one or more nutritional components including, for example, vitamins, vitamin B12, vitamin D, vitamin C, vitamin A, vitamin E, vitamin B, vitamin K, thiamine, riboflavin, pyridoxine, carotenoids, beta-carotene, zeaxanthin, lutein, lycopene, niacin, folic acid, pantothenic acid, biotin, choline, inositol, 1-methionine, 1-serine, 1-threonine, and combinations thereof.

### Product Format and Packaging

A frozen confection of this invention may be packaged in a various containers.

Examples of containers include bags, cups, jars, tubs, bottles, bowls, boxes, cans, cartons, bags-in-boxes, tubes, capsules, vacuum packaging pouches, Tetra Pak® containers, brick, gable top, liquid aseptic packaging, roll fed liquid aseptic packaging, and/or single serve box.

A frozen confection can be made in a format including an ice cream format, a novelty, a frozen shake format, a frozen mousse format, a frozen fudge format, a frozen custard format, a sherbet format, and combinations thereof.

The containers may be heat and/or light resistant. In some embodiments, the containers can be pre-sterilized. The packaged product may be placed in frozen storage. In some embodiments, the flavor and texture of the product are substantially maintained after storing frozen for at least 6 months, or two years.

The packaging may carry one or more labels that communicate information to the consumer or that support the marketing of the food products. Example of information that may be communicated to the consumer include: dairy-free, free of genetically modified organisms, free of gluten, Kosher, free of cholesterol, vegetarian, vegan, free of dairy allergen, free of soy, free of nuts, and combinations thereof.

The following paragraphs describe embodiments of the inventions disclosed herein. These embodiments are not meant to be limiting.

1. A frozen confection, comprising a plant protein, a sweetener, an oil, a bulking component, a texturizer, and an emulsifier, wherein the frozen confection is dairy-free.

2. The frozen confection of paragraph 1, comprising:

a sweetener in an amount of from 11% to 18% by weight;

an oil in an amount of from 7% to 15% by weight;

a bulking component in an amount of from 7% to 15% by weight;

a plant protein isolate or refined protein in an amount of from 2% to 6% by weight;

a texturizer in an amount of from 0.5% to 5% by weight; and

an emulsifier comprising two or more gums, wherein the total is from 0.2% to 2% by weight;

wherein the frozen confection is also gluten-free.

3. The frozen confection of paragraph 1, further comprising a flavorant in an amount up to about 5% by weight.

4. The frozen confection of paragraph 3, wherein the flavorant is one or more components selected from natural flavorants, taste modifiers, sodium chloride, sea salt, sodium citrate, potassium citrate, potassium phosphate, dipotassium phosphate, vanilla, cocoa, mint, cinnamon, honey, blueberry, strawberry, raspberry, mango, citrus, lemon, orange, coconut, passion fruit, peach, and combinations thereof.

5. The frozen confection of paragraph 1, further comprising a lecithin in an amount up to 1% by weight.

6. The frozen confection of paragraph 5, wherein the lecithin is sunflower lecithin.

7. The frozen confection of paragraph 1, further comprising a solubilizer in an amount up to 0.5% by weight.

8. The frozen confection of paragraph 7, wherein the solubilizer is dipotassium phosphate.

9. The frozen confection of paragraph 1, further comprising a deacidifier in an amount up to 1% by weight.

10. The frozen confection of paragraph 9, wherein the deacidifier is potassium hydroxide.

11. The frozen confection of paragraph 1, wherein the sweetener is selected from cane sugar, beet sugar sucrose, allulose, fructose, glucose, maltose, galactose, dextrose, corn syrup, and combinations thereof.

12. The frozen confection of paragraph 11, wherein the sweetener is cane sugar.

13. The frozen confection of paragraph 1, wherein the oil is selected from coconut oil, soybean oil, sunflower oil, palm oil, flaxseed oil, oat oil, illipe oil, shea oil, shorea robusta oil, cocoa butter oil, corn oil, aloe vera oil, avocado oil, baobab oil, calendula oil, canola oil, pumpkin oil, cottonseed oil, evening primrose oil, grape seed oil, jojoba oil, neem oil, olive oil, rapeseed oil, sesame oil, and combinations thereof.

14. The frozen confection of paragraph 13, wherein the oil is coconut oil.

15. The frozen confection of paragraph 1, wherein the bulking component is selected from tapioca syrup, polydextrose, maltodextrin, corn syrup solids, and combinations thereof.

16. The frozen confection of paragraph 15, wherein the bulking component is tapioca syrup.

17. The frozen confection of paragraph 1, wherein the plant protein is an isolated or refined protein is from:

a legume selected from alfalfa, asparagus bean, asparagus pea, baby lima bean, black bean, black-eyed pea, black turtle bean, Boston bean, Boston navy bean, broad bean, cannellini bean, carob, cassia, chickpea, chili bean, cranberry bean, dwarf bean, Egyptian bean, Egyptian white broad bean, English bean, fava bean, fava coceira, fenugreek, field pea, French green bean, frijol bola roja, frijole negro, great northern bean, green pea, kidney bean, lentil, lespedeza, licorice, lima bean, lupini bean, Madagascar bean, mesquite, Mexican black bean, Mexican red bean, molasses face bean, mung bean, mung pea, mungo bean, navy bean, pea bean, peanut, Peruvian bean, pinto bean, red bean, red clover, red eye bean, red kidney bean, rice bean, runner bean, scarlet runner bean, small red bean, snow pea, southern pea, sugar snap pea, soy bean, tamarind, wax bean, white clover, white kidney bean, white pea bean, wisteria, yellow pea, and combinations thereof;

a grain selected from quinoa, sorghum, oat, wheat, spelt, teff, rice, corn, and combinations thereof;

a tuber selected from potato, sweet potato, cassava, yam, taro, canna, arrowroot, and combinations thereof; or

an oil seed selected from sunflower, flax, canola, cottonseed, hemp, chia, and combinations thereof.

18. The frozen confection of paragraph 17, wherein the plant protein isolate or refined protein is from pea.

19. The frozen confection of paragraph 18, wherein the pea is Pisum sativum.

20. The frozen confection of paragraph 17, wherein the plant protein isolate or refined protein comprises about 5-95% by weight of protein, or about 70-90% by weight of protein.

21. The frozen confection of paragraph 1, wherein the plant protein isolate is extracted in a solvent to remove lipids, or is heat treated to remove volatiles, or is fermented, or is gelled.

22. The frozen confection of paragraph 17, wherein the refined plant protein is from a non-allergenic or hypoallergenic source.

23. The frozen confection of paragraph 17, wherein the refined plant protein is precipitated at an acid pH.

24. The frozen confection of paragraph 17, wherein the refined plant protein is salt-precipitated.

25. The frozen confection of paragraph 17, wherein the refined plant protein is salt-precipitated at an acid pH.

26. The frozen confection of paragraph 17, wherein the refined plant protein has an aqueous solubility of less than about 15, 14, 13, 12, 11, 10, 9, 8, 7, 6, 5, 4, 3, 2 or 1% (w/w).

27. The frozen confection of paragraph 17, wherein the refined plant protein has a solution pH of less than about 7.1, 7.0, 6.9, 6.8, 6.7, 6.6, 6.5, 6.4, 6.3, 6.2, 6.1, 6.0, 5.9, 5.8. 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1 or 3.0.

28. The frozen confection of paragraph 17, wherein the refined plant protein has a sodium content of less than about 4500, 4000, 3500, 3000, 2500, 2000, 1500, 1000, 900 or 800 ppm ppm.

29. The frozen confection of paragraph 17, wherein the refined plant protein is prepared by a process, comprising:

a) obtaining a protein preparation from a plant;

b) washing the protein preparation at a wash pH;

c) extracting the protein preparation at an extraction pH to obtain an aqueous protein solution;

d) separating the aqueous protein solution from non-aqueous components;

e) optionally, adding salt;

f) adjusting the aqueous protein solution to a precipitation pH to precipitate protein and obtain a protein precipitate;

g) separating the protein precipitate from non-precipitated components; and

h) washing the protein precipitate to obtain the refined plant protein preparation.

30. The frozen confection of paragraph 29, wherein one or more of the steps are performed at a temperature of between 50-70 or 60-70° C.

31. The frozen confection of paragraph 29, wherein the refined plant protein preparation has a solution pH of less than about 7.1, 7.0, 6.9, 6.8, 6.7, 6.6, 6.5, 6.4, 6.3, 6.2, 6.1, 6.0, 5.9, 5.8. 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9, 3.8, 3.7, 3.6, 3.5, 3.4, 3.3, 3.2, 3.1 or 3.0.

32. The frozen confection of paragraph 1, wherein the texturizer is selected from sugars, fiber, maltodextrin, inulin, fructo oligosaccharides, pectin, carboxymethyl cellulose, guar gum, corn starch, oat starch, potato starch, rice starch, wheat starch, amaranth flour, oat flour, quinoa flour, rice flour, rye flour, sorghum flour, soy flour, wheat flour, corn flour, barley bran, carrot fiber, citrus fiber, corn fiber, corn bran, soluble dietary fiber, insoluble dietary fiber, oat bran, pea fiber, rice bran, head husks, soy fiber, soy polysaccharide, wheat bran, wood pulp cellulose, and combinations thereof.

33. The frozen confection of paragraph 32, wherein the texturizer is inulin.

34. The frozen confection of paragraph 2, wherein the gums are selected from xanthan gum, bean gum, guar gum, gum arabic, gum ghatti, gum karaya, gum tragacanth, gellan gum, acacia, locust bean gum, carrageenan, cellulose gum, cellulose gel, pectin, gelatin, agar, furcellaran, dextran, beta-glucan, dammar gum, glucomannan, mastic gum, psyllium seed husks, tara gum, quillaia gum and combinations thereof.

35. The frozen confection of paragraph 34, wherein the gums are guar gum, gum Arabic, and locust bean gum.

36. The frozen confection of paragraph 1, wherein the pH of the frozen confection is from 7.1 to 8.3, or from 7.3 to 8.3.

37. The frozen confection of paragraph 1, wherein the frozen confection has reduced off taste, as compared to a conventional dairy-free frozen confection.

38. The frozen confection of paragraph 1, wherein the frozen confection has a shiny appearance when scooped, as compared to a conventional dairy-free frozen confection.

39. The frozen confection of paragraph 1, wherein the frozen confection has a creamy mouth feel, as compared to a conventional dairy-free frozen confection.

40. The frozen confection of paragraph 1, comprising a serving size of from 50 mL to 15,000 mL, 50 mL to 4000 mL, or from 50 mL to 1000 mL, or from 50 mL to 500 mL, or from 50 mL to 250 mL, or from 50 mL to 125 mL.

41. The frozen confection of paragraph 1, further comprising confectionary inclusions.

42. The frozen confection of paragraph 1, wherein the frozen confection has an overrun of from 40% to 150%.

43. The frozen confection of paragraph 1, wherein the frozen confection is aged at a temperature of about 4-10° C. (40-50° F.) for at least 2 hours before filling and freezing.

44. A process for making a dairy-free frozen confection product, the process comprising:

batching a dairy-free frozen confection composition with pH adjustment;

homogenizing the composition;

thermally processing the composition;

chilling and ageing at least a portion of the composition at a temperature of about 4-10° C. (40-50° F.) for at least 2 hours; and

filling and freezing the composition into the frozen confection product.

45. The process of paragraph 44, wherein the batching comprises:

preparing a dairy-free frozen confection composition comprising:

a sweetener in an amount of from 11% to 18% by weight;

an oil in an amount of from 7% to 15% by weight;

a bulking component in an amount of from 7% to 15% by weight;

a plant protein isolate in an amount of from 2% to 6% by weight;

a texturizer in an amount of from 0.5% to 5% by weight; and

an emulsifier comprising two or more gums in a total amount of from 0.2% to 2% by weight.

46. The process of paragraph 44, wherein the homogenizing is performed at about 5-25 MPa, or about 10-18 MPa.

47. The process of paragraph 44, wherein the thermal processing is performed for about 30 seconds to about 30 minutes and about 57° C. to 99° C., or about 79° C. (about 135° F. to 210° F., or about 175° F., respectively) using an indirect high temperature short time system.

48. The process of paragraph 44, wherein flavorants and/or inclusions are added during the chilling step.

49. The process of paragraph 44, wherein the frozen confection product has an overrun of from 40% to 150%.

50. The process of paragraph 44, wherein the frozen confection product comprises a serving size of from 50 mL to 15,000 mL, or from 50 mL to 4000 mL, or from 50 mL to 1000 mL, or from 50 mL to 500 mL, or from 50 mL to 250 mL, or from 50 mL to 125 mL.

51. A dairy-free frozen confection made by the process of any of paragraph 44-50.

All publications, including patent and non-patent publications, referred to herein are hereby expressly incorporated by reference in their entirety for all purposes.

Although the foregoing disclosure has been described in detail by way of example for purposes of clarity of understanding, it will be apparent to the artisan that certain changes and modifications are comprehended by the disclosure and may be practiced without undue experimentation within the scope of the appended claims, which are presented by way of illustration not limitation. This invention includes all such additional embodiments, equivalents, and modifications. This invention includes any combinations or mixtures of the features, materials, elements, or limitations of the various illustrative components, examples, and claimed embodiments.

The terms “a,” “an,” “the,” and similar terms describing the invention, and in the claims, are to be construed to include both the singular and the plural.

### EXAMPLES

The following examples are for illustrating various embodiments and are not to be construed as limitations.

### Example 1

A white base formula is made as shown in Table 4.

TABLE 4
White base aqueous formula

| INGREDIENT | Wt % |
|---|---|
| Sugar | 11-18 |
| Coconut Oil | 7-15 |
| Tapioca Syrup Solids | 7-15 |
| RIPPTEIN | 2-6 |
| Inulin | 1-5 |
| Gum Arabic | 0.2-2 |
| Dipotassium Phosphate | 0.01-1 |
| Sea Salt | 0.01-0.5 |
| Sunflower Lecithin | 0.01-0.8 |
| Locust Bean Gum | 0.01-0.5 |
| Guar Gum | 0.01-0.5 |
| Potassium Hydroxide | 0-1 |

### Example 2

A chocolate base formula is made as shown in Table 5.

TABLE 5
Chocolate base aqueous formula

| INGREDIENT | Wt % |
|---|---|
| Cane Sugar | 11-18 |
| Coconut Oil | 7-15 |
| Tapioca Syrup Solids | 7-15 |
| RIPPTEIN | 2-8 |
| Cocoa Powder | 1-5 |
| Inulin | 1-5 |
| Gum Arabic | 0.2-2 |
| Dipotassium Phosphate | 0.01-1 |
| Sea Salt | 0.01-0.5 |
| Sunflower Lecithin | 0.01-0.8 |
| Locust Bean Gum | 0.01-0.5 |
| Guar Gum | 0.01-0.5 |
| Potassium Hydroxide | 0-1 |

### Example 3

A vanilla-flavored, dairy-free frozen confection product was made according to Example 1. A panel of 24 participants who consumed dairy and/or non-dairy frozen desserts was recruited. The format used was a hybrid focus group. The participants observed and tasted the frozen confections, and then completed questionnaires containing questions related to visual, texture, vanilla flavor, sweetness and aftertaste of the products. Second, there was a round of discussion in the group to further understand personal likes and dislikes related to the frozen confections. The frozen confections tested by the panelists were: i) the vanilla-flavored, dairy-free frozen confection product made according to Example 1; ii) a vanilla-flavored non-dairy product from a competitor; and iii) a vanilla-flavored dairy product from a competitor.

The vanilla-flavored, dairy-free frozen confection product made according to Example 1 scored a surprising rating of 79% “like” visual appearance, 87% “like” texture, and 24% “unpleasant aftertaste” under a taste panel, as well as an unexpectedly advantageous preference of 72% to 28% over the dairy-free frozen confection product from the competitor. These results showed that the product was found surprisingly appealing and had superior low off taste.

### Example 4

A chocolate-flavored frozen confection product was made according to Example 1 and evaluated by a panel, as described in Example 3, comparing the confection of Example 1 with a chocolate-flavored non-dairy product from a competitor.

The chocolate-flavored frozen confection product made according to Example 1 scored a surprising rating of 69% “like” texture and 14% “unpleasant aftertaste” under a taste panel, as well as an unexpectedly advantageous preference of 72% to 28% over a conventional dairy-free frozen confection product. These results showed that the product was surprisingly appealing and had superior low off taste.

### Example 5

A mint chocolate-flavored frozen confection product was made according to Example 1 and evaluated by a panel, as described in Example 3, comparing the confection of Example 1 with a mint chocolate-flavored non-dairy product from a competitor. The product scored a surprising rating of 79% “like” texture and 14% “unpleasant aftertaste” under a taste panel, as well as an unexpectedly advantageous preference of 72% to 28% over a conventional dairy-free frozen confection product. These results showed that the product was surprisingly appealing and had superior low off taste.

### Example 6

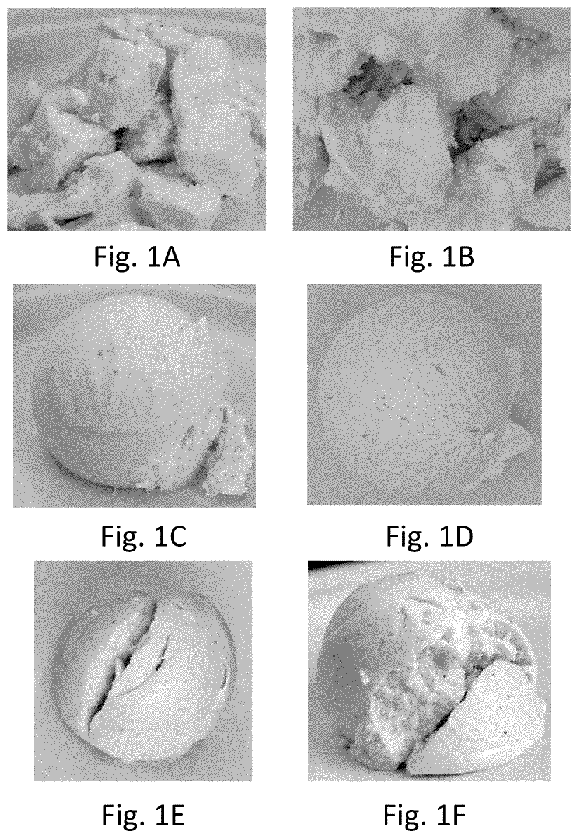

The vanilla-flavored, dairy-free frozen confection product made according to Example 1 was scooped and visually compared with scoops of dairy-free frozen confection products made by two different competitors. Photographs were taken of the scooped products and are shown in FIG. 1A-FIG. 1F.

FIGS. 1A and 1B are from the first competitor product. Scoops of this product did not hold together. Also, the product had a dry appearance (i.e., not shiny).

FIGS. 1C and 1D are from the second competitor product. Scoops of this product held their shape. This product also had a dry appearance.

FIGS. 1E and 1F are from the product made according to Example 1. Scoops of this product held their shape. Initially, this product also had a dry appearance. However, after slight melting, the scoops appeared shiny. This shininess was not observed in either of the two competitor products. FIGS. 1E and 1F also show fracturing, cracking or “rippling” of the frozen confection across the scoop. This frequently occurred during scooping of this product and was not generally seen in the competitor products.

### Example 7

The refined protein preparations used to prepare the frozen confections herein are salt-precipitated plant proteins. In these examples, the salt-precipitated plant protein used is calcium-precipitated pea protein. The calcium-precipitated refined pea protein preparations used in these studies was compared with two other commercially available refined protein preparations, also from pea plants, that were not salt-precipitated. Herein, the two commercially available refined protein preparations are referred to as Competitor #1 and Competitor #2. All three refined protein preparations (i.e., the salt-precipitated, Competitor #1 and Competitor #2 preparations) were in powder form. The three refined protein preparations were characterized as described below.

In one set of studies, the particle size distribution (D×50) for each refined protein preparation was determined and is shown in Table 6. Although not shown, the distribution of particle sizes for each protein preparation was unimodal and roughly symmetrical.

Solubility in water was also determined for each protein preparation and is shown in Table 6. To determine solubility, a 5% protein load was added to 10 ml of water at room temperature and a slurry was made. After 30 minutes, the slurry was centrifuged and the amount of protein in the supernatant was determined using a combustion method. Solubility was calculated.

The pH of water that contained a 10% (w/w) solution of the refined protein preparations was determined and is shown in Table 6. To make this determination, water was supersaturated with the protein preparation at 10% (w/w) and pH of the solution was then determined.

Finally, the amount of sodium, on a ppm basis, was determined for each protein preparation and is shown in Table 6.

TABLE 6
Properties of Refined Proteins
Used in HMMAs, Meat Analogues and Meat Hybrids

| | | Aqueous | Solution | Sodium |
|---|---|---|---|---|
| Protein | | Solubility | pH | Content |
| Preparation | Dx50 (μm) | (% w/w) | (10% w/w) | (ppm) |
| Salt-precipitated | 50 | 2 | 5.5 | 802 |
| protein | , | | | |
| Competitor #1 | 114 | 21 | 7.4 | 7530 |
| Competitor #2 | 36 | 15 | 7.1 | 4640 |

The data showed that the salt-precipitated protein preparation had a particle size (50 μm) smaller than the particle size of Competitor #1 (114 μm) and larger than the size of Competitor #2 (36 μm). The aqueous solubility of the salt-precipitated protein (2%) was less than the aqueous solubility of both Competitor #1 (21%) and Competitor #2 (15%) protein preparations.

The pH of a 10% solution of the salt-precipitated protein (5.5) was less than a 10% solution of both Competitor #1 (7.4) and Competitor #2 (pH 7.1) protein preparations.

In other studies (not shown here), the solution pH of independently prepared salt-precipitated protein preparations was similarly determined. The mean±standard deviation of the solution pH of 5 independently prepared salt-precipitated protein preparations was 5.45±0.12.

Also, the sodium content of the salt-precipitated protein (802 ppm) was less than that of both Competitor #1 (7530 ppm) and Competitor #2 (4640 ppm) protein preparations.

In a second study, pea protein preparations prepared in the same way as the salt-precipitated preparation used above, except that the protein precipitation step was performed at acidic pH with no added salt, were examined for pH. The solution pH, determined as described above, was determined for 16 independently prepared protein preparations. The mean and variation of these determinations was 5.63±0.11.

What is claimed is:

1. A non-dairy frozen confection, comprising a salt-precipitated acidic pH or non-salt-precipitated acidic pH plant protein preparation.

2. The non-dairy frozen confection of claim 1, including a sweetener, an oil, a bulking component, a texturizer, and an emulsifier.

3. The non-dairy frozen confection of claim 2, including:
the sweetener in an amount of from 11% to 18% by weight;
the oil in an amount of from 7% to 15% by weight;
the bulking component in an amount of from 7% to 15% by weight;
the plant protein preparation in an amount of from 2% to 6% by weight;
the texturizer in an amount of from 0.5% to 5% by weight; and
the emulsifier comprising two or more gums, wherein a total is from 0.2% to 2% by weight; and
wherein the non-dairy frozen confection is gluten-free.

4. The non-dairy frozen confection of claim 3, including:
a solubilizer in an amount up to 0.5% by weight.

5. The non-dairy frozen confection of claim 4, including:
a flavorant in an amount up to about 5% by weight.

6. The non-dairy frozen confection of claim 1, wherein the plant protein preparation is from a legume source.

7. The non-dairy frozen confection of claim 6, wherein the plant protein preparation is from a pea source.

8. The non-dairy frozen confection of claim 1, wherein the plant protein preparation has an aqueous solubility of less than about 15% (w/w).

9. The non-dairy frozen confection of claim 1, wherein the plant protein preparation has a solution pH of less than about 7.1.

10. The non-dairy frozen confection of claim 1, wherein the non-dairy frozen confection has an overrun of from 40% to 150%.

11. The non-dairy frozen confection of claim 1, wherein the non-dairy frozen confection is aged at a temperature of about 4-10° C. (40-50° F.) for at least 2 hours before filling and freezing.

12. The non-dairy frozen confection of claim 11, wherein the non-dairy frozen confection has a shiny appearance when scooped, as compared to a conventional dairy-free frozen confection.

13. A process for making a non-dairy frozen confection, comprising:
batching a dairy-free frozen confection composition with pH adjustment;
homogenizing the composition;
thermally processing the composition;
chilling and ageing at least a portion of the composition at a temperature of about 4-10° C. (40-50° F.) for at least 2 hours; and
filling and freezing the composition into the non-dairy frozen confection.

14. The process of claim 13, wherein the batching comprises:
preparing a dairy-free frozen confection composition including:
a sweetener in an amount of from 11% to 18% by weight;
an oil in an amount of from 7% to 15% by weight;
a bulking component in an amount of from 7% to 15% by weight;
a plant protein preparation in an amount of from 2% to 6% by weight;
a texturizer in an amount of from 0.5% to 5% by weight; and
an emulsifier comprising two or more gums in a total amount of from 0.2% to 2% by weight.

15. The process of claim 14, wherein the plant protein preparation is prepared by a process, comprising:
a) obtaining a protein preparation from a plant;
b) optionally, washing the protein preparation at a wash pH;
c) extracting the protein preparation at an extraction pH to obtain an aqueous protein solution;
d) separating the aqueous protein solution from non-aqueous components;
e) optionally, adding salt;
f) adjusting the aqueous protein solution to a precipitation pH to precipitate protein and obtain a protein precipitate;
g) separating the protein precipitate from non-precipitated components; and
h) washing the protein precipitate to obtain the plant protein preparation.

16. The process of claim 15, wherein the plant protein preparation has a solution pH of less than about 7.1.
